(19) United States
(12) Patent Application Publication
(10) Pub. No.: US 2026/0326152 A1
(43) Pub. Date: Oct. 22, 2026

(54) SYSTEMS AND METHODS FOR ORGANIZING INTERLOCKING TOY BRICKS AND ASSOCIATED ITEMS

(71) Applicant: MSK Consulting, Sugar Land, TX (US)

(72) Inventors: Dhyan Suman Krishnan, Sugar Land, TX (US); Uday Krishnan, Sugar Land, TX (US); Monica Suman Krishnan, Sugar Land, TX (US)

(21) Appl. No.: 19/646,087

(22) Filed: Apr. 13, 2026

Related U.S. Application Data
(60) Provisional application No. 63/790,222, filed on Apr. 17, 2025.
(60) Provisional application No. 63/887,269, filed on Sep. 24, 2025.

(51) Int. Cl. B07C 5/342; B07C 5/10

(52) U.S. Cl. CPC B07C 5/3422; B07C 5/10

(57) ABSTRACT

An interlocking toy brick organizing apparatus may include a receiving compartment configured to receive a plurality of items comprising interlocking toy bricks, a sensor device configured to measure a parameter associated with each item that enters the receiving compartment, a storage area configured to store each item, a handling device configured to move each item from the receiving compartment to the storage area, and a controller. The controller may be configured to obtain measurements of the parameter made by the sensor device and identify each item based on the measurements. The controller may also be configured to control the handling device to move each item from the receiving compartment to one of the plurality of storage compartments of the storage area based on identifying each item.

### CROSS-REFERENCE TO RELATED APPLICATIONS

This application claims priority under 35 U.S.C. § 119 to U.S. Provisional Patent Application Ser. No. 63/790,222 titled “SmartBrickSort: A home friendly system for sorting interlocking toy bricks by color, shape, and size.” and filed on Apr. 17, 2025, the entire contents of which are hereby incorporated herein by reference. This application also claims priority under 35 U.S.C. § 119 to U.S. Provisional Patent Application Ser. No. 63/887,269 titled “SmartBrickSort Companion Application: Mobile and Cloud System for Real-Time Brick Sorting, Inventory Tracking, and Build Assistance” and filed on Sep. 24, 2025, the entire contents of which are hereby incorporated herein by reference.

### TECHNICAL FIELD

The present disclosure relates generally to interlocking toy bricks, and more particularly to systems, methods, and devices for organizing interlocking toy bricks and associated items.

### BACKGROUND

Interlocking toy bricks and associated items are popular items, particularly for children and teenagers. Often, a package or set of interlocking toy bricks are provided so that, when the interlocking toy bricks are assembled, a particular assembly (e.g., an object, a scene) results. Each of these sets may include hundreds or even thousands of individual bricks. When a set is disassembled, the process of identifying and organizing the individual toy bricks can be a time consuming process. Individuals often have multiple sets of interlocking toy bricks to assemble multiple objects and/or scenes. Multiple sets that are disassembled may significantly increase the difficulty of keeping the individual interlocking toy bricks from one set separated from those from another set. In other words, organizing the interlocking toy bricks can be a significant challenge.

### SUMMARY

In general, in one aspect, the disclosure relates to interlocking toy brick organizing apparatus. The interlocking toy brick organizing apparatus may include a receiving compartment configured to receive a plurality of items comprising interlocking toy bricks. The interlocking toy brick organizing apparatus may also include a sensor device configured to measure a parameter associated with each item that enters the receiving compartment. The interlocking toy brick organizing apparatus may further include a storage area configured to store each item, where the storage area comprises a plurality of storage compartments. The interlocking toy brick organizing apparatus may also include a handling device configured to move each item from the receiving compartment to the storage compartment. The interlocking toy brick organizing apparatus may further include a controller that is configured to obtain measurements of the parameter made by the sensor device, and identify each item based on the measurements. The controller of the interlocking toy brick organizing apparatus may also be configured to control the handling device to move each item from the receiving compartment to one of the plurality of storage compartments of the storage area based on identifying each item.

In another aspect, the disclosure can generally relate to a method for organizing a set of interlocking toy bricks. The method may include obtaining, by a controller from a sensor device, measurements of a parameter associated with each of a plurality of items, where the plurality of items comprises interlocking toy bricks, and where the sensor device measures the parameter while the plurality of items are in a receiving compartment of an organizing apparatus. The method may also include identifying, by the controller using the measurements, each item. The method may further include controlling, by the controller, a handling device of the organizing apparatus to move each item from the receiving compartment to one of a plurality of storage compartments of a storage area based on identifying each item.

In another aspect, the disclosure can generally relate to a software application used for organizing a set of interlocking toy bricks, wherein the software application is loaded on a mobile device and is configured to present a prompt for a user to capture an image of a plurality of items using an image capturing device on the mobile device, where the plurality of items includes interlocking toy bricks. The software application may also be configured to obtain, from the image capturing device, the image. The software application may further be configured to analyze contents of the image. The software application may also be configured to identify, after analyzing the contents of the image, each of the plurality of items. The software application may further be configured to present, after identifying each of the plurality of items, an inventory of the items.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a diagram of a system for organizing interlocking toy bricks and associated items according to certain example embodiments.

FIG. 2 shows a diagram of a controller of the organizing apparatus of FIG. 1.

FIG. 3 shows a computing system according to certain example embodiments.

FIG. 4 shows a flowchart of a method for organizing interlocking toy bricks and associated items according to certain example embodiments.

FIG. 5 shows a flowchart of a method for using a software application to organize interlocking toy bricks and associated items according to certain example embodiments.

FIG. 6 shows a screenshot of a user system according to certain example embodiments.

FIG. 7 shows another screenshot of the user system of FIG. 6 according to certain example embodiments.

FIG. 8 shows another screenshot of the user system of FIG. 7 according to certain example embodiments.

FIG. 9 shows another screenshot of the user system of FIG. 8 according to certain example embodiments.

FIG. 10 shows an organizing apparatus according to certain example embodiments.

FIGS. 11A and 11B show a rear view and a top view, respectively, of another organizing apparatus according to certain example embodiments.

FIGS. 12A through 12D show various views of an item in the form of a toy interlocking brick according to certain example embodiments.

### DETAILED DESCRIPTION

The example embodiments discussed herein are directed to systems, methods, and devices for organizing interlocking toy bricks and associated items. Example embodiments can be used by people who own, possess, sell, and/or otherwise interact with interlocking toy bricks and associated items. Example embodiments can be used in any of a number of situations. For example, example embodiments can be used to help a person (defined as a user herein) organize items from set. As another example, example embodiments can be used to help a user determine whether items are missing from a set and, if so, identify the one or more particular missing items from the set. As yet another example, example embodiments can be used to provide a detailed accounting of items in inventory. As another example, example embodiments can be used to provide to a user one or more possible assemblies (including detailed guidance) that particular items in inventory may be used to create.

In certain example embodiments, systems and methods for organizing interlocking toy bricks and associated items may be subject to meeting certain standards and/or requirements. Examples of agencies and other entities that can set applicable standards and/or regulations can include, but are not limited to, the Occupational Safety and Health Administration (OSHA), Underwriters Laboratories (UL), the Federal Communication Commission (FCC), and the Institute of Electrical and Electronics Engineers (IEEE). Use of example embodiments described herein meet (and/or allow a corresponding device to meet) such standards when required.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number or a four digit number, and corresponding components in other figures have the identical last two digits.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of organizing interlocking toy bricks and associated items are described more fully hereinafter with reference to the accompanying drawings, in which example embodiments of organizing interlocking toy bricks and associated items are shown. Organizing interlocking toy bricks and associated items may, however, be embodied in many different forms and should not be construed as limited to the example embodiments set forth herein. Rather, these example embodiments are provided so that this disclosure will be thorough and complete, and will fully convey the scope of organizing interlocking toy bricks and associated items to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation, and such terms are not meant to limit embodiments of organizing interlocking toy bricks and associated items. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

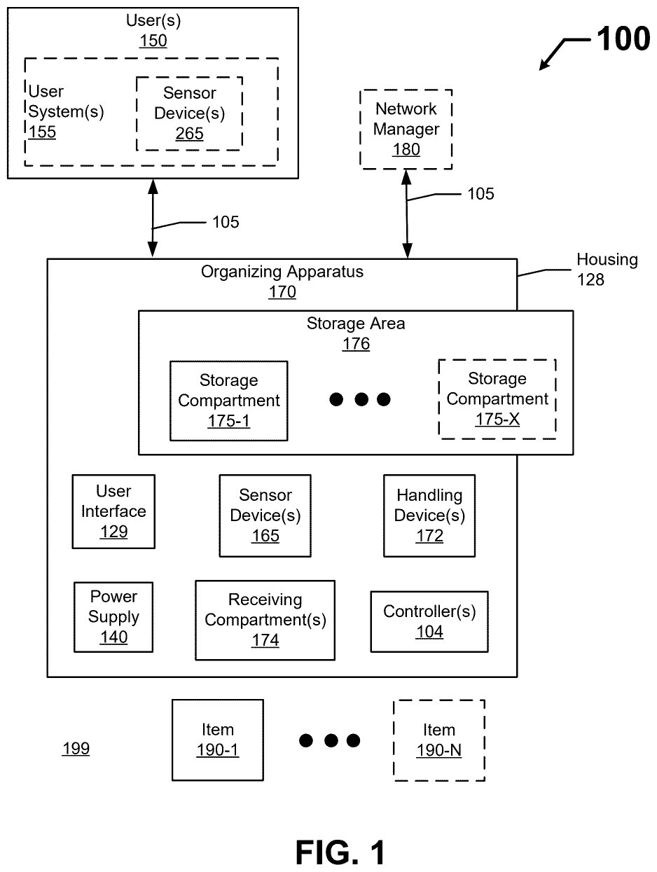

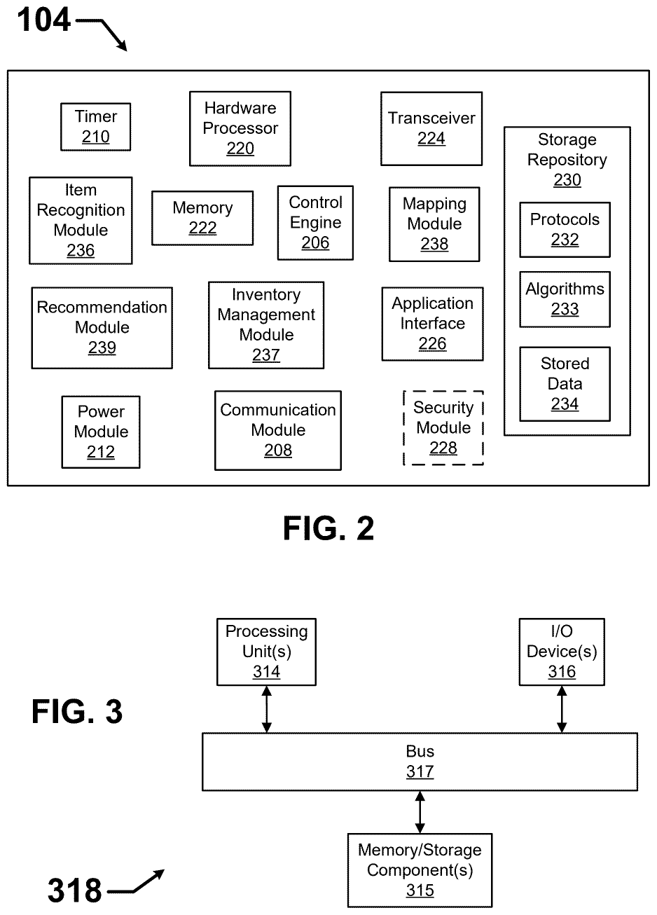

FIG. 1 shows a diagram of a system 100 for organizing interlocking toy bricks and associated items in accordance with certain example embodiments. FIG. 2 shows a diagram of a controller 104 of the organizing apparatus 170 (also sometimes called an interlocking toy brick organizing apparatus 170 herein) of FIG. 1. Referring to FIGS. 1 and 2, the system 100 includes one or more users 150 with one or more user systems 155, an optional network manager 180, the organizing apparatus 170, and multiple items 190 located in a volume of space 199. The organizing apparatus 170 can include multiple components. For example, in this case, the organizing apparatus 170 includes one or more controllers 104, a user interface 129, one or more sensor devices 165, a storage area 176 having one or more storage compartments 175, one or more handling devices 172, one or more receiving compartments 174, and a power supply 140.

As discussed above, the organizing apparatus 170 and/or other parts of the system 100 may include one or more controllers 104. A controller 104 of the organizing apparatus 170 and/or other parts of the system 100 communicates with and in some cases controls one or more of the other components (e.g., a sensor device 165, a receiving component 174, a handling device 172) of the organizing apparatus 170 and/or another component (e.g., an app on a user system 155) of the system 100. A controller 104 performs a number of functions that include obtaining and sending data, evaluating data, following protocols, running algorithms, and sending commands. In some cases, a controller 104 may be, control, and/or communicate with an app on a user system 155 that is directed to example embodiments.

Each controller 104 of the organizing apparatus 170 can include any of a number of components. For example, as shown in FIG. 2, a controller 104 can include a control engine 206, an item recognition module 236, an inventor management module 237, a mapping module 238, a recommendation module 239, a communication module 208, a timer 210, a power module 212, a storage repository 230, a hardware processor 220, a memory 222, a transceiver 224, an application interface 226, and, optionally, a security module 228. The storage repository 230 of a controller 104 can be organized by multiple categories. For example, in this case, the storage repository 230 includes one or more protocols 232, one or more algorithms 233, and stored data 234.

The organizing apparatus 170 and the items 190 are located in a volume of space 199. The volume of space 199 can be any indoor and/or outdoor area in which the one or more items 190 are located. A volume of space can be a single room or multiple rooms in a structure (e.g., a house, an apartment building, a professional office building, a store). Examples of a volume of space 199 can include, but are not limited to, a bedroom or play room of a house or an apartment, a bedroom closet, an area within a child care facility, a waiting room at a doctor's office, an area in a toy store or an area in a department store, an area in a flea market, a living room, a family room, a patio, a deck, a basement, and a garage. In some cases, the volume of space 199 can include multiple rooms in a building (e.g., a house, a store, an apartment).

The components shown in FIGS. 1 and 2 are not exhaustive, and in some embodiments, one or more of the components shown in FIGS. 1 and 2 may not be included in the system 100 or portions thereof (e.g., the organizing apparatus 170). For example, any component of the organizing apparatus 170 can be discrete or combined with one or more other components of the organizing apparatus 170. For instance, at least part of the storage repository 230 can be located externally (e.g., in the cloud) from the housing 128 of the organizing apparatus 170. As another example, the organizing apparatus 170 can include one or more additional components (e.g., an antenna, a switch) that are not shown in FIGS. 1 and 2. As still another example, one or more of the sensor devices 165 can be located external to the housing 128 of the organizing apparatus 170.

An item 190 can be anything that is used in an assembly of toy bricks. The system 100 can include a number (e.g., 10, 150, 498, 1329, 4821, 11862) of items 190 located in the volume of space 199. For example, in this case, there are N items 190 (item 190-1 through item 190-N). Examples of an item 190 may include, but are not limited to, a brick, a figurine, a base, a sign, a light fixture, an antenna, an item of food, a plate, a drinking glass, a shoe, a hat, a purse, and a scarf. An item 190 can have any shape, overall size, color(s), manufacturer, design number, other types of markings, type (e.g., stud, tube) of interlocking features, number of interlocking features, size of interlocking features, location of interlocking features, and/or other characteristics. When there are multiple items 190 in the volume of space 199, one item 190 may be physically separated from the other items 190, loosely co-mingled with one or more of the other items 190, and/or connected to (e.g., coupled to) one or more of the other items 190.

A user 150 may be any person that interacts with one or more of the items 190, the organizing apparatus 170 (including components thereof), the optional network manager 180, and/or another component of the system 100. Examples of a user 150 may include, but are not limited to, a child, an adult, a store owner, an employee, a customer, a parent, a hobbyist, a collector, a sales person, a landlord, a consultant, a contractor, and a manufacturer's representative.

In certain example embodiments, a user 150 directly (e.g., physically, verbally, using hand gestures) interacts with the user interface 129 of the organizing apparatus 170. In addition, or in the alternative, a user 150 interacts with the user interface 129 of the organizing apparatus 170 using one or more user systems 155, which may include a display (e.g., a GUI). A user system 155 may be any device that has the software and hardware sufficient to allow the user 150 to enable and use example embodiments through the user interface 129. Examples of a user system 155 can include, but are not limited to, an android device (or equivalent), a tablet, smartphones, a laptop computer, a desktop computer, a handheld device, and a personal digital assistant (PDA). A user system 155 (or portions thereof) can be portable or stationary.

The user interface 129 of the organizing apparatus 170 may be communicably coupled to one or more other components (e.g., a controller 104 of the organizing apparatus 170, a user system 155) within the system 100. For example, when the user interface 129 is communicably coupled to a controller 104 of the organizing apparatus 170, the user interface 129 may be configured to receive an input from a user 150 (e.g., directly, via an associated user system 155), and the controller 104 (including modules thereof) may operate based on the input from the user 150. The user interface 129 may be configured to be usable by a user 150 of any age (e.g., a 5 year old, a 10 year old, an 80 year old).

In some cases, a user system 155 of a user 150 includes one or more sensor devices 265. A sensor device 265 of a user system 155 may be substantially the same as a sensor device 165 (discussed below) of the organizing apparatus 170. For example, a sensor device 265 of a user system 155 may be in the form of an image capturing device (e.g., a still camera, a video camera) that is integrated with a user system 155 in the form of a smart phone. In this way, a sensor device 265 in the form of an image capturing device may capture one or more images of one or more items 190 in the volume of space 199. In such cases, images captured by a user 150 on a user system 155 may be sent (e.g., using communication links 105) to a controller 104 of the organizing apparatus 170. In some cases, as with collaborations, school projects, community projects, and the like, multiple users 150 may share inventories and/or assemblies to build via a software application (also referred to as an app herein) on a user system 155 of each user 150 in a group.

In addition, or in the alternative, software (e.g., in the form of an app) on the user system 155 may be used to perform some of the functions (e.g., identifying a color of an item 190, identifying a shape of an item 190, identifying a size of an item 190, identifying a manufacturer of an item 190, identifying a design number of an item 190, identifying other types of markings of an item 190, identifying a number of interlocking features of an item 190, identifying a type (e.g., stud, tube) of interlocking feature of an item 190) that are discussed below as being performed by the item recognition module 236 of a controller 104 of the organizing apparatus 170. An app on a user system 155 may be an extension of or a complement to the user interface 129 (discussed below) of the organizing apparatus 170.

Interaction (including transmission of radio frequency (RF) signals and/or other types of communication signals) between the users 150 (including associated user systems 155), the network manager 180, and the organizing apparatus 170 (including components thereof) may be facilitated using communication links 105. Similarly, communication and/or other interaction between components (e.g., between a controller 104 and a sensor device 165, between a controller 104 and a handling device 172) of the organizing apparatus 170 can be facilitated using communication links 105.

Each communication link 105 can include one or more wired (e.g., Class 1 electrical cables, Class 2 electrical cables, Power Line Carrier, RS485, DALI, electrical connectors) and/or wireless (e.g., Wi-Fi, visible light communication, cellular networking, Bluetooth, BLE, Zigbee, LoRa, ultra-wideband (UWB), WirelessHART, ISA100) technology. For example, a communication link 105 can be (or include) one or more electrical conductors that are coupled to various components of the system 100. The communication links 105 can transmit signals (e.g., power signals, communication signals (e.g., RF signals), control signals, data) between the organizing apparatus 170, the users 150 (including the associated user systems 155), and/or the network manager 180. For example, a controller 104 of the organizing apparatus 170 can broadcast communication signals to one or more user systems 155 of the system 100 at a given time and from a given location within the volume of space 199 using BLE over the communication links 105.

The optional network manager 180 is a device or component that controls all or a portion of the system 100. The network manager 180 can be substantially similar to a controller 104 of the organizing apparatus 170. Alternatively, the network manager 180 can include one or more of a number of features in addition to, or altered from, the features of a controller 104 of the organizing apparatus 170. There can be more than one network manager 180 and/or one or more portions of a network manager 180. In some cases, a network manager 180 can be called by other names, including but not limited to an insight manager, a master controller, a network coordinator, and a network controller. The network manager 180 may be located in the volume of space 199 or remotely from the volume of space 199.

The housing 128 of the organizing apparatus 170 includes one or more walls. The walls of the housing 128 may form a cavity inside of which one or more components (e.g., a controller 104, a storage compartment 175, a handling device 172, a sensor device 165, the power supply 140) may be located. In some cases, one or more components (or portions thereof) of the organizing apparatus 170 may be located on and/or integrated with the housing 128. For example, some or all of the user interface 129 may be located on and/or integrated with the housing 128. As another example, one or more receiving compartments 174 (or portions thereof) may be located on and/or integrated with the housing 128. The housing 128 may be made of one or more of a number of suitable materials (e.g., plastic, wood, metal, plexiglass, glass). In some cases, the housing 128 can be designed to comply with any applicable standards so that the organizing apparatus 170 may be located in a particular environment (e.g., outdoors).

The user interface 129 of the organizing apparatus 170 is configured to provide control, information, queries, feedback, and/or other interactions with a user 150. The user interface 129 may be an apparatus having physical components (e.g., buttons, dials, a touch screen, a microphone, a speaker) disposed on and/or integrated with the housing 128 of the organizing apparatus 170. In addition, or in the alternative, the user interface 129 may be a virtual-based interface that interacts with a user system 155 (e.g., using one or more communication links 105). The user interface 129 may have a number of different capabilities and functions. Examples of such capabilities and functions may include, but are not limited to, control of one or more of the handling devices 172, the status of one or more of the handling devices 172, the current inventory (e.g., identification of items 190 (e.g., in terms of number, in terms of color, in terms of shape, in terms of size, in terms of weight) in one or more of the storage compartments 175 of the storage area 176), the time, the status of the power supply 140, and the status of each receiving compartment 174.

Each receiving compartment 174 of the organizing apparatus 170 may be configured to receive one or more items 190 for processing. Each receiving compartment 174 is integrated with the housing 128 (e.g., an outer wall of the housing 128) to allow items 190 to transition from the ambient volume of space 199 to inside the housing 128. Examples of a receiving compartment 174 may include, but are not limited to, a hole, a hopper, a chute, an inverted funnel, a door, a sliding panel, a drawer, and a slot. Each receiving compartment 174 may have characteristics (e.g., shape, size, location relative to the housing 128) that allow the items 190 to enter within the housing 128. Each receiving compartment 174 may be designed to be safe for use by young children.

A handling device 172 of the organizing apparatus 170 is configured to move (e.g., turn, rotate, roll, change location) each item 190 during one or more stages (e.g., before, during, after) of the process of organizing each item 190. In addition, a handling device 172 may be configured to perform other functions (e.g., separate multiple items 190 that are joined or coupled together so that the individual items 190 may be properly identified) in organizing items 190. A handling device 172 may have a number of different configurations. Examples of a handling device 172 may include, but are not limited to, a mechanical arm, a conveyor belt, a vibrating platform, a tumbler, a nozzle that blows compressed air (e.g., in puffs, continually), a blower, a rotating or otherwise movable baffle, a funnel, a channel, an aperture, a diverter arm, an auger, and a chute. In some cases, multiple handling devices 172 may be used to handle an item 190 simultaneously. For example, two handling devices 172 in the form of mechanical arms may work simultaneously in concert to pull two or more joined items 190 apart from each other.

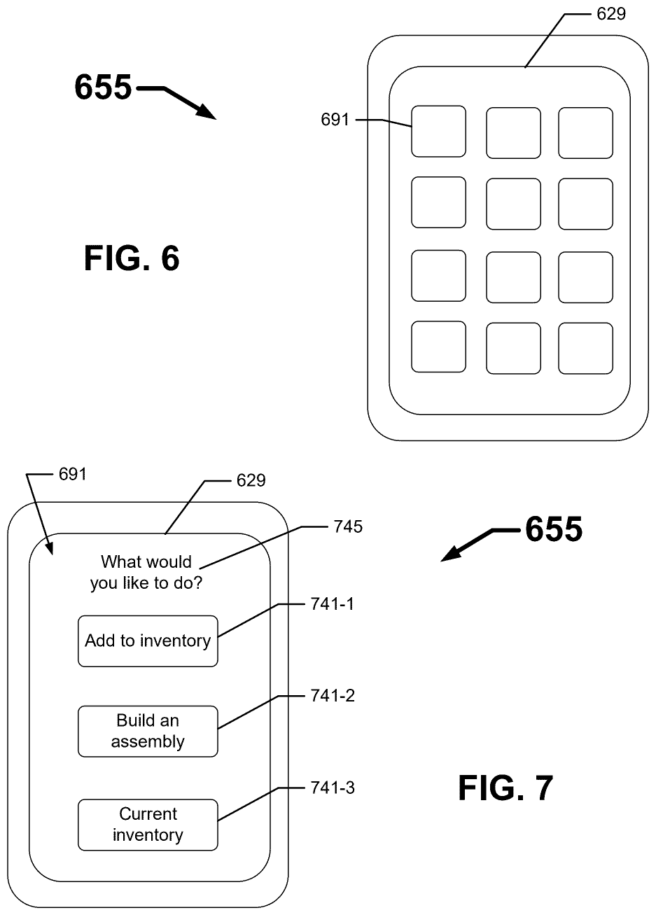

In certain example embodiments, a handling device 172 may be integrated with and/or work in conjunction with a receiving compartment 174. For example, as shown in FIG. 6 below, a handling device 172 in the form of a conveyer belt may extend through a receiving compartment 174 in the form of a hole in the housing 128 of the organizing apparatus 170. In certain example embodiments, a handling device 172 may be configured to move an item 190 from the receiving compartment 174 to the storage area 176. For example, a handling device 172 in the form of a mechanical arm may be configured to move an item 190 to a receiving compartment 174 after the item 190 has been categorized.

A handling device 172 may be configured to be controlled by a controller 104. For example, the movement (e.g., grab, lift, release, rotate, extend, bend, retract, straighten, stop) of a handling device 172 in the form of a mechanical arm may be controlled, in whole or in part, by a controller 104. As another example, the rate of vibration of a handling device 172 in the form of a vibrating platform may be controlled, in whole or in part, by a controller 104. In some cases, a handling device 172 may additionally or alternatively be controlled by a user 150, including an associated user system 155, using the user interface 129.

A handling device 172 may operate, at least in part, based on measurements made by one or more of the sensor devices 165. For example, when a sensor device 165 (e.g., in the form of a camera) identifies and categorizes an item 190, a controller 104 may direct a handling device 172 to put the item 190 in a particular storage compartment 175 in the storage area 176. As another example, when a sensor device 165 (e.g., in the form of a scale, e.g., in the form of a motion sensor) detects that one or more items 190 have been put into or through a receiving compartment 174, a controller 104 may direct a handling device 172 to manipulate the one or more items 190 so that one or more other sensor devices 165 may be able to identify and categorize each of those items 190.

A handling device 172 of the organizing apparatus 170 may be located entirely within the housing 128. In addition, or in the alternative, a handling device 172 may be located outside the housing 128 within the volume of space 199. In addition, or in the alternative, a handling device 172 may be positioned on (e.g., coupled to, integrated with) the housing 128. In some cases, a handling device 172 operates inside and outside the housing 128, either at the same time or at different times.

In certain example embodiments, one or more handling devices 172 may be configured to clean and/or sanitize some or all of the items 190. For example, a handling device 172 may be in the form of an ultraviolet light (UV) source that emits UV light that is directed toward one or more items 190. In such cases, the UV light may kill any bacteria, viruses, mold, and the like that are on one or more surfaces of the items 190, thereby disinfecting the items 190. Also, in such cases the handling device 172 in the form of a UV light source, as well as the UV light that it emits, may be contained within the housing 128 so that there is no risk of eye damage to a user 150. Under this scenario, one or more other handling devices 172 (e.g., in the form of an auger, in the form of a rotating cylinder, in the form of a paddle wheel) may be used to move the items 190 in a way that allows the UV light emitted by the UV light source to come into contact with more of the surfaces of the items 190.

As another example, a handling device 172 may be in the form of a spray with soapy water, disinfectant, and/or some other fluid that is directed toward one or more items 190. In such cases, the fluid dispensed by the handling device 172 may remove dirt, food stains, spilled soft drinks, and/or other similar materials that are stuck to one or more of the items 190. Additional handling devices 172 (in the form of a scrubber, in the form of a drying cloth, in the form of a water spray to rinse the fluid sprayed by the other handling device 172) may be involved in this process to clean the items 190.

The storage area 176 of the organizing apparatus 170 includes a number (e.g., 1, 2, 3, 5, 10, 25, 43) of storage compartments 175. In this case, the storage area 176 has X storage compartments 175 (storage compartment 175-1 through storage compartment 175-X). Some or all of the storage area 176 may be located within the housing 128 of the organizing apparatus 170. In addition, or in the alternative, some or all of the storage area 176 may be located outside the housing 128. In some cases, a storage compartment 175 that is located within the housing 128 may be removable from the housing 128 by a user 150.

Each storage compartment 175 of the organizing apparatus 170 may be configured to receive and store one or more items 190 after those items 190 have been identified. A storage compartment 175 may be located with the housing 128, integrated with the housing, and/or located outside the housing 128. A storage compartment 175 in the storage area 176 may be accessible (e.g., via a door, via a panel, via a drawer, via a selection on the user interface 129) to a user 150. A storage compartment 175 may have a number of configurations, including but not limited to a tray, a bin, a container, a receptacle, a box, and an open space. Each storage compartment 175 may have characteristics (e.g., shape, size, location relative to the housing 128) that allow the items 190 to be stored therein. When the storage area 176 of an organizing apparatus 170 has multiple storage compartments 175, the characteristics (e.g., shape, size, location) of one storage compartment 175 may be the same as, or different than, the corresponding characteristics of one or more of the other storage compartments 175. A storage compartment 175 may be directly accessible by a user 150 (e.g., a storage compartment 175 is located in the volume of space 199 outside the housing 128, a storage compartment 175 is located inside the housing 128 but is part of a drawer that is integrated with a wall of the housing 128 and can be pulled out by the user 150).

In some cases, a storage compartment 175 may include multiple sub-compartments, sub-sub-compartments, bins, divisions, sub-divisions, etc. that allow for the organization and storage of items 190 having differing characteristics (e.g., colors, shapes, sizes, manufacturers) within the storage compartment 175. In such cases, the size and/or number of the different sub-compartments and the like within a storage compartment 175 may be adjusted, merged, further divided, etc. from time to time (e.g., using one or more handling devices 172 as controlled by a controller 104) as the organization of the items 190 may require or dictate.

The organizing apparatus 170 may have a number (e.g., 1, 2, 4, 8, 13, 19, 25, 39) of sensor devices 165. Each sensor device 165 of the organizing apparatus 170 can include one or more sensors, where each sensor is configured to measure one or more parameters associated with an item 190. Examples of types of sensors of a sensor device 165 may include, but are not limited to, a camera, a passive infrared sensor, a photocell, a pressure sensor, an air flow monitor, a proximity sensor, an ammeter, a voltmeter, a load cell, an accelerometer, and a gyroscope. Examples of a parameter that is measured by a sensor device 165 may include, but are not limited to, presence of an item 190, movement of a handline device 172, available capacity within a storage compartment 175, dimensions of an item 190, color of an item 190, markings (e.g., manufacturer logo, manufacturer name, model number, serial number) on an item 190, features (e.g., number of interlocking features, types (e.g., stud, tube) of interlocking features, location of interlocking features, cracks or other defects) on an item 190, voltage, current, speed, and an amount of weight.

A sensor device 165 may be an integrated sensor (also sometimes called an integrated sensor device 165). In integrated sensor has both the ability to sense and measure at least one parameter and the ability to communicate with another component (e.g., a controller 104 of the organizing apparatus 170). The communication capability of a sensor device 165 that is an integrated sensor may include one or more communication devices that are configured to communicate with, for example, a user system 155 and/or the network manager 180.

Each sensor device 165, whether integrated or not, may use one or more of a number of communication protocols. This allows a sensor device 165 to communicate with one or more components (e.g., the control engine 206 of the controller 104, one or more other integrated sensor devices 165) of the system 100. The communication capability of a sensor device 165 that is an integrated sensor can be dedicated to the sensor device 165 and/or shared with a controller 104 of the organizing apparatus 170. When the system 100 includes multiple integrated sensor devices 165, one integrated sensor device 165 can communicate, directly or indirectly, with one or more of the other integrated sensor devices 165 in the system 100.

If the communication capability of a sensor device 165 that is an integrated sensor is dedicated to the sensor device 165, then the sensor device 165 can include one or more components (e.g., a transceiver 224, a communication module 208), or portions thereof, that are substantially similar to the corresponding components described above with respect to the controller 104. A sensor device 165 can be integrated with a controller 104 of the organizing apparatus 170, can be a stand-alone device, and/or can be integrated with another component in the system 100. A sensor device 165 can be located within the housing 128 of the organizing apparatus 170, disposed on the housing 128 of the organizing apparatus 170, or located outside the housing 128 of the organizing apparatus 170.

In certain example embodiments, a sensor device 165 can include an energy storage device (e.g., a battery) that is used to provide power, at least in part, to some or all of the sensor device 165. In such a case, the energy storage device can be the same as, or independent of, the power supply 140 of the organizing apparatus 170. The optional energy storage device of the sensor device 165 can operate at all times or when the power supply 140 of the organizing apparatus 170 is interrupted. Further, a sensor device 165 can utilize or include one or more components (e.g., memory 222, storage repository 230, transceiver 224) found in a controller 104. In such a case, a controller 104 can provide the functionality of these components used by the sensor device 165. Alternatively, the sensor device 165 can include, either on its own or in shared responsibility with a controller 104, one or more of the components of a controller 104. In such a case, the sensor device 165 can correspond to a computer system as described below with regard to FIG. 3.

As discussed above, a sensor device 165 may be in the form of an image capturing device. In such a case, the image capturing device may be configured to capture one or more images of one or more items 190. A sensor device 165 in the form of an image capturing device may be or include a video camera, a still camera, and/or another type of camera. As such, an image captured by an image capturing device may be or include a still image, a series of still images, a live shot, and/or a moving image (e.g., a video). In some cases, a sensor device 165 in the form of an image capturing device may include or be connected to a microphone, speaker, or other audio device to detect sound and/or emit sound associated with an image captured by the image capturing device.

In some cases, a sensor device 165 in the form of an image capturing device may include one or more features (e.g., pan, zoom, tilt, focus) that allow the image capturing device to capture a usable image (e.g., not blurry, not capturing an image that excludes one or more items 190). In such cases, the one or more features of the image capturing device may be controlled automatically (e.g., by a controller 104) and/or by a user 150 (including an associated user system 155). If a sensor device 165 (e.g., in the form of an image capturing device, in some other form) is unable to accurately measure one or more parameters of an item 190, the sensor device 165 and/or a controller 104 may control one or more handling devices 172 to manipulate one or more items 190 in order to take accurate measurements.

When the organizing apparatus 170 includes multiple sensor devices 165 in the form of image capturing devices, one image capturing device can work independently of or in conjunction with one or more of the other image capturing devices. A sensor device 165 (e.g., in the form of an image capturing device, in some other form) may have or include the capability of a geolocation service so that the location of each parameter (e.g., an image) that is measured may be ascertained. Further, a sensor device 165 (e.g., in the form of an image capturing device, in some other form) may have or include the capability of a timestamp so that the date and time that each parameter (e.g., an image) that is measured may be ascertained.

The power supply 140 of the organizing apparatus 170 is configured to provide power to one or more other components of the organizing apparatus 170. The power supply 140 may include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 may include one or more components (e.g., a transformer, a diode bridge, an inverter, a converter) that receives power (for example, through an electrical cable) from a power source (e.g., AC mains, a battery), manipulates (e.g., transforms, inverts, converts) that power, and subsequently sends the manipulated power to one or more other components (e.g., a controller 104, a sensor device 165, a handling device 172, the user interface 129) of the organizing apparatus 170. The power supply 140 can generate power of a type (e.g., alternating current, direct current) and level (e.g., 12V, 24V, 120V) that can be used by the recipients (e.g., the sensor devices 165, a controller 104) of such power. In addition, or in the alternative, the power supply 140 can receive power from a source external to the organizing apparatus 170. In addition, or in the alternative, the power supply 140 may be or include a source of power in itself. For example, the power supply 140 may be or include one or more energy storage devices (e.g., a battery, a supercapacitor), a localized photovoltaic power system, and/or some other source of independent power.

The organizing apparatus 170 may have a number (e.g., 1, 2, 5, 12, 25) of controllers 104. A controller 104 of the organizing apparatus 170 can send communication signals (e.g., RF signals) to and/or communication signals (e.g., receive RF signals) from one or more of the other components of the organizing apparatus 170, one or more of the user systems 155, and/or the network manager 180 in the system 100. A controller 104 of the organizing apparatus 170 can use one or more of a number of communication protocols (e.g., part of the protocols 232) in sending communication signals to and/or receiving communication signals from one or more of the other components of the organizing apparatus 170, one or more of the user systems 155, and/or the network manager 180.

The network manager 180, the one or more user systems 155, and the other components (e.g., the sensor devices 165, the user interface 129, the power supply 140, the handling devices 172, other controllers 104) of the organizing apparatus 170 may interact with a controller 104 of the organizing apparatus 170 using the application interface 226 in accordance with one or more example embodiments. Specifically, the application interface 226 of a controller 104 receives data (e.g., information, communications, instructions) from and sends data (e.g., information, communications, instructions) to the network manager 180, the one or more user systems 155, and/or one or more of the other components (e.g., the sensor devices 165, the user interface 129, the power supply 140, the handling devices 172, other controllers 104) of the organizing apparatus 170. The network manager 180, the one or more user systems 155, and/or one or more of the other components (e.g., the sensor devices 165, the user interface 129, the power supply 140, the handling devices 172, other controllers 104) of the organizing apparatus 170 may include an interface to receive data from and send data to a controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

A controller 104 of the organizing apparatus 170, the network manager 180, the one or more user systems 155, and/or one or more of the other components (e.g., the sensor devices 165, the user interface 129, the power supply 140, the handling devices 172, other controllers 104) of the organizing apparatus 170 may use their own system or share a system in certain example embodiments. Such a system may be, or contain a form of, an Internet-based or an intranet-based computer system that is capable of communicating with various software. A computer system includes any type of computing device and/or communication device, including but not limited to a controller 104. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 3.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The storage repository 230 of a controller 104 can be a persistent storage device (or set of devices) that stores software and data used to assist the controller 104 in communicating with a user 150 (including an associated user system 155), the network manager 180, and/or one or more of the other components (e.g., the sensor devices 165, the user interface 129, the power supply 140, the handling devices 172, other controllers 104) of the organizing apparatus 170 within the system 100. In one or more example embodiments, the storage repository 230 stores one or more protocols 232, one or more algorithms 233, and stored data 234.

The protocols 232 can be any procedures (e.g., a series of method steps) and/or other similar operational procedures that the control engine 206 of a controller 104 follows based on certain conditions at a point in time. A protocol 232 can include a process for identifying one or more characteristics (e.g., color, shape, overall size, manufacturer, design number, other types of markings, types (e.g., stud, tube) of interlocking features, number of interlocking features, size of interlocking features, location of interlocking features) of an item 190. In addition, or in the alternative, a protocol 232 can include a process for matching item 190 with one of a list of potential items stored as stored data 234 based on the identified characteristics of the item 190. Protocols 232 may be evaluated (e.g., using past data, using current data) and adjusted from time to time by the control engine 206 so that such protocols 232 can be more efficient, accurate, and/or reliable in the future.

The protocols 232 can further include any of a number of communication protocols that are used to send and/or receive data between a controller 104 and one or more of the user systems 155, the network manager 180, and/or one or more of the other components (e.g., the sensor devices 165, the user interface 129, the power supply 140, the handling devices 172, other controllers 104) of the organizing apparatus 170. One or more of the protocols 232 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 232 used for communication can provide a layer of security to the data transferred within the system 100.

The algorithms 233 can be any formulas, mathematical models, forecasts, simulations, and/or other similar tools that the control engine 206 of the controller 104 uses to reach a computational conclusion. As an example, one or more algorithms 233 can be used to calculate the number of an item 190 with certain configurations needed for a particular assembly. As another example, one or more algorithms 233 can be used to identify one or more colors (including shades of a color) of an item 190. Algorithms 233 can be used to analyze past data, analyze current data, and/or perform forecasts. Algorithms 233 can be evaluated (e.g., using past data, using current data) and adjusted from time to time by the control engine 206 so that such algorithms 233 can be more accurate and reliable in the future. One or more particular algorithms 233 can be used in conjunction with one or more particular protocols 232. For example, one or more protocols 232 and one or more algorithms 233 can be used in conjunction with each other to identify and categorize an item 190 to determine which storage compartment 175 the item 190 is to be placed in by one or more of the handling devices 172.

Stored data 234 can be any data associated with the items 190, any data associated with the user systems 155, any data associated with the various components of the organizing apparatus 170, any data associated with the network manager 180, any measurements taken by the sensor devices 165 and the sensor devices 265, threshold values, user preferences, results of previously run or calculated algorithms 233, inventory lists, potential assemblies (including an itemized list of items 190 for each assembly), and/or any other suitable data. Such stored data 234 can be any type of data, including historical data, present data, and forecasts. In some cases, the stored data 234 may be associated with some measurement of time derived, for example, from the timer 210.

When the stored data 234 is in the form of images captured by a sensor device (e.g., sensor device 165, sensor device 265) in the form of an image capturing device, an image may be live (e.g., a real-time video feed) or previously captured or recorded. Some or all of these previously captured or recorded images may be of one or more items 190 within the volume of space 199 and/or inside the housing 128 of the organizing apparatus 170. An image may be organized by time that the image was captured, by items 190 captured in the image, by a location of the image (e.g., within the volume of space 199, within the housing 128), based on some other factor, or based on any suitable combination thereof. In some cases, one or more of the images may be from or of an item from an external site (e.g., a type of user system 155) as a point of reference or comparison for images of items 190.

Examples of a storage repository 230 may include, but are not limited to, a database (or a number of databases), a file system, a hard drive, flash memory, cloud-based storage, some other form of solid state data storage, or any suitable combination thereof. The storage repository 230 may be located on multiple physical machines, each storing all or a portion of the protocols 232, the algorithms 233, and/or the stored data 234 according to some example embodiments. Each storage unit or device of the storage repository 230 may be physically located in the same or in a different geographic location.

The storage repository 230 may be operatively connected to the control engine 206 and/or other components (e.g., the item recognition module 236, the inventory management module 237) of a controller 104. In one or more example embodiments, the control engine 206 includes functionality to communicate with the network manager 180, the one or more user systems 155 (including any sensor devices 265), the sensor devices 165, the user interface 129, the power supply 140, the handling devices 172, other controllers 104, and/or other components of the controller 104. For example, the control engine 206 may send information to and/or receive information from the storage repository 230 in order to communicate with the network manager 180, the user systems 155 (including any sensor devices 265), the sensor devices 165, the user interface 129, the power supply 140, the handling devices 172, other controllers 104, and/or other components of the controller 104. As discussed below, the storage repository 230 can also be operatively connected to the communication module 208 in certain example embodiments.

In certain example embodiments, the control engine 206 of a controller 104 controls the operation of one or more other components (e.g., the item recognition module 236, the mapping module 238, the inventory management module 237, the communication module 208, the timer 210, the transceiver 224) of the controller 104. For example, the control engine 206 can put the communication module 208 in “sleep” mode when there are no communications between the controller 104 and another component (e.g., the network manager 180, another controller of the organizing apparatus 170) in the system 100 or when communications between the controller 104 and another component in the system 100 follow a regular pattern. In such a case, power consumed by the controller 104 is conserved by only enabling the communication module 208 when the communication module 208 is needed.

As another example, the control engine 206 may direct the timer 210 when to provide a current time, to begin tracking a time period, and/or perform another function within the capability of the timer 210. As yet another example, the control engine 206 may direct the transceiver 224 to send RF signals (or other types of communication signals) and/or stop sending RF signals (or other types of communication signals) to the network manager 180, a user system 155 (including any sensor devices 265), one or more sensor devices 165, the user interface 129, a handling device 172, and/or some other component in the system 100.

The control engine 206 of a controller 104 may use one or more protocols 232, one or more algorithms 233, and/or stored data 234 to determine one or more characteristics (e.g., color, shape, overall size, manufacturer, design number, other types of markings, types (e.g., stud, tube) of interlocking features, number of interlocking features, size of interlocking features, location of interlocking features) of one or more items 190. The control engine 206 of a controller 104, in conjunction with the item recognition module 236, may use one or more protocols 232, one or more algorithms 233, and/or stored data 234 to identify an item 190 based on the characteristics of the item 190. The control engine 206 of a controller 104, in conjunction with the inventory management module 237, may use one or more protocols 232, one or more algorithms 233, and/or stored data to match an item 190 with an item 190 among a list of potential items 190. The control engine 206 of a controller 104, in conjunction with the inventory management module 237, may use one or more protocols 232, one or more algorithms 233, and/or stored data to designate which storage compartment 175 is to receive a particular item 190.

The control engine 206 of a controller 104, in conjunction with the mapping module 238, may use one or more protocols 232, one or more algorithms 233, and/or stored data 234 to identify which assembly or assemblies may be built using the items 190 available in inventory (e.g., stored in the storage area 176). The control engine 206 of a controller 104, in conjunction with the recommendation module 239, may use one or more protocols 232, one or more algorithms 233, and/or stored data 234 (e.g., user preferences) to recommend an assembly or assemblies that a user 150 may build using the items 190 available in inventory (e.g., stored in the storage area 176).

A control engine 206 of a controller 104 may be configured to determine, based on measurements made by one or more sensor devices 165, that there is an obstruction involving one or more items 190 within the housing 128. The control engine 206 may determine how such an obstruction may be cleared and control one or more handling devices 172 in an attempt to clear the obstruction. If the obstruction remains, the control engine 206 may be configured to notify a user 150 (e.g., via the user interface 129, via an app on a user system 155).

In certain example embodiments, a controller 104 of the organizing apparatus 170 can receive communication signals from the network manager 180, the one or more user systems 155 (including any sensor devices 265), the sensor devices 165, the user interface 129, the power supply 140, the handling devices 172, other controllers 104, and/or other components of the controller 104. In such a case, the control engine 206 of the controller 104 can use the protocols 232 and/or the algorithms 233 to receive such communication signals and interpret the content of those communication signals.

The control engine 206 can provide control, communication, and/or other similar signals to the network manager 180, the one or more user systems 155 (including any sensor devices 265), the sensor devices 165, the user interface 129, the power supply 140, the handling devices 172, other controllers 104, and/or other components of the controller 104. Similarly, the control engine 206 can receive control, communication, and/or other similar signals from the network manager 180, the one or more user systems 155 (including any sensor devices 265), the sensor devices 165, the user interface 129, the power supply 140, the handling devices 172, other controllers 104, and/or other components of the controller 104.

The control engine 206 can communicate with the network manager 180, the one or more user systems 155 (including any sensor devices 265), the sensor devices 165, the user interface 129, the power supply 140, the handling devices 172, other controllers 104, and/or other components of the controller 104 automatically (for example, based on one or more protocols 232 stored in the storage repository 230) and/or based on control, communication, and/or other similar signals received from another component (e.g., a sensor device 165, a user system 155) using communication signals. The control engine 206 may include a printed circuit board, upon which the hardware processor 220 and/or one or more discrete components of the controller 104 are positioned.

In certain embodiments, the control engine 206 of a controller 104 may communicate with one or more components of a system external to the system 100. For example, the control engine 206 can interact with an inventory management system by ordering a new item 190 to replace an item 190 currently in inventory that the control engine 206 has identified as being broken. As another example, the control engine 206 can interact with a workforce scheduling system by scheduling a maintenance crew to repair or replace a sensor device 165 (e.g., in the form of an image capturing device) when the control engine 206 determines that the sensor device 165 or portion thereof requires maintenance or replacement. As another example, the control engine 206 can interact with a third party site (e.g., of a manufacturer, of a vendor, of a site that facilitates the resale of items 190) to purchase and/or sell items 190 that are needed for building an assembly and/or to offload items 190 that are no longer wanted by a user 150. In this way, the controller 104 is capable of performing a number of functions beyond what could reasonably be considered a routine task.

The control engine 206 of the controller 104, through the use of one or more protocols 232, one or more algorithms 233, and/or stored data 234, may implement machine learning as a way to evolve over time with new data and associated changes that may result from the new data. The control engine 206 may use, for example, supervised learning, unsupervised learning, semi-supervised learning, and/or reinforcement learning, as those terms are known in the art of machine learning. In this case, these types of machine learning are effective with sufficient data (e.g., measurements from sensor devices 165, data obtained from a user system 155, feedback received from a user 150) and use of algorithms 233 and/or protocols 232 that automatically build and/or revise mathematical models using sample data (also known as “training data”) from among the stored data 234.

In this way, for example, one or more of the various modules (e.g., the item recognition module 236, the inventor management module 237, the mapping module 238, the recommendation module 239, the control engine 206) of a controller 104 of the organizing apparatus 170 may translate the code embodied in the methodology definition of the organizing apparatus 170 to the data structures and/or code on a user system 155 using data and language elements native to that user system 155. In this way, the organizing apparatus 170 may not require special software to communicate with, reside, and/or function on the user system 155. Rather, the organizing apparatus 170, by way of the learning protocols 232 and/or algorithms 233, uses features native to the user system 155 to execute the methodology with the permission of the user system 155. These learning protocols 232 and/or algorithms 233 may be used to match information from a user system environment that is known (e.g., previously observed with the same or a different user system 155) or unknown to the data solutions in the methodology. Using this flexibility allowed by the learning protocols 232 and/or algorithms 233, the organizing apparatus 170 may scale to disparate vendor solutions and ‘build’ customized data solutions and instructions to translate between those vendor solutions and the data contract for the methodology. The learning algorithms 233 may use or include large language models (LLM) to implement unique classification/semantic matching properties that may assist in the development of customized data solutions and/or instructions for the organizing apparatus 170.

The learning protocols 232 and/or algorithms 233 that may be used and trained by one or more of the various modules (e.g., the item recognition module 236, the inventor management module 237, the mapping module 238, the recommendation module 239, the control engine 206) of a controller 104 of the organizing apparatus 170 may include, but are not limited to, instance-based learning algorithms, artificial neural network algorithms, deep learning algorithms, and ensemble algorithms. Instance-based learning algorithms typically build up a database of example data and compare new data to the database using a similarity measure in order to find the best match and make a prediction. For this reason, instance-based methods are also called winner-take-all methods and memory-based learning. Focus may be put on the representation of the stored instances and similarity measures used between instances. Instance-based algorithms may be computationally expensive for very large datasets since they save all training instances/data points and are sensitive to data noise.

Artificial neural networks may be fairly similar to the human brain. For example, artificial neural networks may be made up of artificial neurons, take in multiple inputs, and produce specific outputs. Artificial neural networks may be an enormous subfield comprised of a large number of neural network architectures and hundreds of algorithms and variations for different types of problems. Artificial neural networks may be biologically inspired computational simulations for certain specific tasks like clustering, classification, or pattern recognition.

Deep learning algorithms may be a modern update to artificial neural networks by building much larger and more complex neural networks. With deep learning, many methods may be applied to very large datasets. Various architectures may be applied for deep learning algorithms. Deep learning may have a high computational cost because much of its development requires advanced processing, storage hardware, and ML platforms/APIs.

Ensemble algorithm methods may be models composed of multiple weaker models that are independently trained and whose predictions are combined in some way to make the overall prediction. Various combination techniques (e.g., averaging, max voting, bagging/bootstrapping (sampling subsets of original complete dataset), boosting) may be applied. Unlike other standard ensemble methods where models are trained in isolation, the boosting technique may employ an iterative approach, training models in succession, with each new model being trained to correct the errors made by the previous ones. Models may be added sequentially until no further improvements may be made.

The control engine 206 (or other components of a controller 104) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 212), even more power can be conserved in the operation of the system 100. In addition, using time-synchronized communication protocols 232, the data transferred between a controller 104, the network manager 180, the one or more user systems 155 (including any sensor devices 265), the sensor devices 165, the user interface 129, the power supply 140, the handling devices 172, other controllers 104, and/or other components of the controller 104 can be secure.

The item recognition module 236 of the controller 104 is configured to identify each item 190 that is processed by the organizing apparatus 170. More specifically, the item recognition module 236 may be configured to identify each characteristic (e.g., color, shape, overall size, manufacturer, design number, other types of markings, types (e.g., stud, tube) of interlocking features, number of interlocking features, size of interlocking features, location of interlocking features) of each item 190 based on measurements made of each item 190 by one or more of the sensor devices 165 and/or one or more sensor devices 265. In this way, the item recognition module 236 is configured to obtain, using the control engine 206, one or more protocols 232, one or more algorithms 233, and/or stored data 234, some or all of the measurements made by one or more of the sensor devices 165 and/or by one or more of the sensor devices 265 with respect to an item 190.

The item recognition module 236 may be configured to manipulate (e.g., format, sort, filter, scale, convert) the measurements made by the sensor devices 165 and/or the sensor devices 265 using the control engine 206, one or more protocols 232, one or more algorithms 233, and/or stored data 234. Identification of an item 190 by the item recognition module 236 may include comparing information obtained by the item recognition module 236 to one or more references (e.g., a table or database of known items 190 in inventory stored as stored data 234, a third party site (e.g., of a retailer, of a manufacturer, of a distributor)). The item recognition module 236 may be configured to make a determination as to whether an item 190 may be identified with a degree of certainty (e.g., 99% certainty, 100% certainty) using one or more protocols 232 and/or one or more algorithms 233.

If the item recognition module 236 is unable to identify an item 190, the item recognition module 236 may notify the inventory management module 237 (to have the item 190 placed in a storage compartment 175 that is designated for miscellaneous and/or unidentified items 190) and the control engine 206 (to consult with external sources of information in an attempt to identify the item 190). In some cases, a user 150 (via the user interface 129, using an app on a user system 155) may reclassify an item 190 that has been identified by the item recognition module 236. Such a reclassification may be passed on to the inventory management module 237 to place the reclassified item 190 in a different storage compartment 175. In such a case, the item recognition module 236 stores this reclassification and uses the reclassified designation on a similar item 190 that is assessed in the future by the item recognition module 236.

In some cases, the item recognition module 236, working in conjunction with the control engine 206, one or more algorithms 233, one or more protocols 232, and/or stored data 234, may determine that more information (e.g., in addition to what is provided initially by one or more sensor devices 165 and/or one or more sensor devices 265) is needed in order to make an identification of an item 190. In such cases, the item recognition module 236, working in conjunction with the control engine 206, one or more algorithms 233, one or more protocols 232, and/or stored data 234, may adjust for lighting (e.g., low lighting, bright lighting, lighting with biased colors and/or temperatures) and/or other ambient conditions in the volume of space 199 and/or within the housing 128 of the organizing apparatus 170 to identify true colors and/or other characteristics of each item 190.

In addition, or in the alternative, the item recognition module 236 may work in conjunction with the control engine 206 to manipulate (e.g., rotate, move, separate) one or more items 190 and/or one or more sensor devices 165 using one or more handling devices 172 in an attempt to obtain additional information about one or more items 190 in order to identify those items 190. In such cases, the item recognition module 236 may identify specific actions that may be taken by specific components (e.g., a handling device 172 in the form of a movable arm, change the focus of a sensor device 165 in the form of a camera) of the categorization apparatus 170 to efficiently obtain the additional information needed to identify and/or categorize an item 190.

If the item recognition module 236 is unable to identify an item 190, the item recognition module 236 may work in conjunction with the control engine 206 to control one or more handling devices 172 to put the unidentified item 190 into a storage compartment 175 that is designated for unidentified items 190. In some cases, when additional information becomes available about an item 190 (e.g., a third party web site is updated, a protocol 232 is updated or added), a previously unidentified items 190 may be retrieved from a storage compartment 175 so that the item 190 may be identified using the additional information.

In some cases, the item recognition module 236 may use information on one or more external sites (e.g., a type of user system 155) to identify and/or categorize one or more characteristics (e.g., a color, a manufacturer, a design number, other types of markings, an overall size, size and location of interlocking features) of an item 190. The item recognition module 236 may be configured to make additions, deletions, and/or modifications to some or all of its identification functions based on any of a number of factors, including but not limited to the release of a new product involving interlocking toy bricks, adjustments in light of actual data, changes in user preferences over time, and the capability of the handling devices 172 and/or sensor devices 165. When the item recognition module 236 identifies an item 190, the information associated with the item 190 may be stored in a table and/or in some other format as the stored data 234. Other functions performed by the item recognition module 236 may be discussed with respect to one or more of the subsequent figures below.

The item recognition module 236 may be configured to detect and differentiate colors of an item 190 based on information provided by one or more of the sensor devices 165 and/or one or more of the sensor devices 265. The item recognition module 236 may be configured to use size heuristics to determine the size of an item 190 based on contour, pixel dimensions, and/or other aspects of an image captured by a sensor device 165 and/or a sensor device 265. The item recognition module 236 may be configured to determine a unique shape of an item 190 using AI and similar adaptive technologies for development and improvement of modeling and identification of an item 190.

The inventory management module 237 of a controller 104 is configured to manage, in real time, an accounting and inventory of all items 190 that have been processed by the item recognition module 236. For example, the inventory management module 237 may determine, based on the identification of an item 190 by the item recognition module 236, which storage compartment 175 in the storage area 176 that the item 190 is stored. In such a case, the inventory management module 237, with the assistance of the control engine 206, one or more protocols 232, one or more algorithms 233, and/or stored data 234, may direct one or more of the handling devices 172 to move the item 190 to the designated storage compartment 175. In addition, the inventory management module 237 may track, as inventory in stored data 234, location of each item 190 within the storage area 176 using one or more protocols 232, one or more algorithms 233, and/or other stored data 234.

As another example, the inventory management module 237 may manage the various storage compartments 175 in the storage area 176 in real time. For example, the inventory management module 237 may determine (e.g., based on an available capacity within a storage compartment 175 as measured by a sensor device 165, based on an estimate of available capacity within a storage compartment 175 using one or more protocols 232, one or more algorithms 233, and/or stored data 234) that a particular storage compartment 175 is at full capacity. In such a case, the inventory management module 237 may take one or more actions in response to a storage compartment 175 being at full capacity. Examples of such actions may include, but are not limited to, notifying a user 150 (including an associated user system 155) that a storage compartment 175 needs to be emptied and/or replaced, prohibiting the handling devices 172 from putting additional items 190 into that storage compartment 175, and designating a different storage compartment 175 as overflow for the full storage compartment 175 to receive additional items 190 that would otherwise be placed in the full storage compartment 175.

The inventory management module 237 may also be configured to manage inventory of the items 190 as certain items 190 are removed from one or more of the storage compartments 175. For example, when a request is made to the controller 104 (e.g., via the user interface 129) for items 190 within a defined assembly and/or for particular items 190, the items 190 associated with the request are removed from one or more of the storage compartments 175 at the direction of the inventory management module 237 using one or more of the handling devices 172, the control engine 206, one or more protocols 232, one or more algorithms 233, and/or stored data 234.

For example, when a user 150 selects an assembly to build, the inventory management module 237 may be configured to control one or more handling devices 172 to retrieve the items 190 (e.g., a subset of all the items in inventory) needed to build the assembly from the storage area 176. In such a case, the inventory management module 237 may also be configured to control the handling devices 237 to place the items 190 in one or more storage compartments 175 that are designated for the assembly. The inventory management module 237 may also be configured to communicate, using the communication module 208, that the items 190 are available for retrieval. In such cases, the inventory management module 237 may receive one or more measurements made by one or more sensor devices 165 and/or by one or more sensor devices 265 so that the inventory management module 237 may determine how many items remain in each of the storage compartments 175 after a user 150 accesses a storage compartment 175 and/or after the inventory management module 237 controls one or more handling devices 172 to move items 190 in preparation for an assembly to be built.

If a request from a user 150 cannot be fulfilled because of a lack of the appropriate items 190 in inventory, the inventory management module 237 may be configured to communicate that the items 190 that are not in the storage area 176 (e.g., not in inventory) while providing the items 190 that fulfill the remainder of the request. The identification of such items 190 in a request may be based on a particular list of items 190, a particular set of building plans. and/or some identification (e.g., by name, by model number) of a particular assembly, as provided by a user 150 (including an associated user system 155), generated by the mapping module 238, and/or selected from the recommendation module 239.

If a request is incomplete or is unclear, the inventory management module 237 may be configured to identify the needed information and communicate the needed information to a user 150 (including an associated user system 155) using the control engine 206, one or more protocols 232, one or more algorithms 233, and/or stored data 234. In some cases, as when a user 150 removes one or more items 190 from one or more of the storage compartments 175, the inventory management module 237 may use the control engine 206, one or more of the sensor devices 165, one or more sensor devices 265, one or more of the handling devices 172, one or more protocols 232, one or more algorithms 233, and/or stored data 234 to correct the inventory in the storage area 176 based on the items 190 that remain in the storage area 176. Other functions performed by the inventory management module 237 may be discussed with respect to one or more of the subsequent figures below.

The inventory management module 237 may be configured to provide (e.g., on the user interface 129 of the organizing apparatus 170, via an app on a user system 155) a real-time inventory report. Such an inventory report may be presented in any of a number of ways (e.g., in a table, in a bar graph, in a pie chart, in a searchable list (e.g., by color, by manufacturer)) to a user 150. The inventory presented by the inventory management module 237 may be dynamic, changing as items 190 are added and/or removed from inventory in real time.

The mapping module 238 of a controller 104 is configured to generate a list of potential assemblies that may be created using the items 190 that are stored in the storage area 176 (i.e., that are in inventory) at a given point in time. The mapping module 238 may generate a list of potential assemblies using the control engine 206, one or more protocols 232, one or more algorithms 233, and/or stored data 234. Potential assemblies may be determined based on prior assemblies saved as stored data 234 in the storage repository 230, searching with third party sites (e.g., using a list of popular assemblies created by people having a similar profile (e.g., age, gender, personal interests) as a user 150), based on a request from a user 150 (including an associated user system 155), and/or by some other source.

The list of potential assemblies generated by the mapping module 238 may be organized in a number of ways and may include varying amounts of information. For example, a list of potential assemblies may include only the name of each assembly. As another example, a list of potential assemblies may include the name, one or more pictures of each completed assembly, a list or roster of items used for each assembly, the estimated time to complete each assembly, instructions on how to build the assembly, and the dimensions of each completed assembly. Other functions performed by the mapping module 238 may be discussed with respect to one or more of the subsequent figures below.

In some cases, one or more of the assemblies proposed by the mapping module 238 of the controller 104 are or are based on an established set of building plans. In addition, or in the alternative, one or more of the assemblies proposed by the mapping module 238 of the controller 104 are based on a set of building plans generated by the mapping module 238 and/or other component (e.g., the control engine 206, the recommendation module 239) of the controller 104 of the organizing apparatus 170.

The recommendation module 239 of a controller 104 is configured to provide a recommendation to a user 150 regarding an assembly to be built from among a list of potential assemblies. The recommendation module 239 may generate a recommendation using the control engine 206, one or more protocols 232, one or more algorithms 233, and/or stored data 234. The recommendation made by the recommendation module 239 may be based on one or more of a number of factors, including but not limited to user preferences (e.g., stated preferences, observed preferences), degree of difficulty, time required to complete, and the inventory that remains after the assembly is completed. If the recommendation module 239 needs more information before making a recommendation, the recommendation module 239 may use the control engine 206, one or more protocols 232, one or more algorithms 233, stored data 234, the communication module 208, the transceiver 224, and/or the application interface 226 to articulate the information needed, communicate a request for needed information to a user 150, receive the needed information from the user 150, and use the information to complete the process of making a recommendation. Other functions performed by the recommendation module 239 may be discussed with respect to one or more of the subsequent figures below.

The communication module 208 of a controller 104 determines and implements the communication protocol (e.g., from the protocols 232 of the storage repository 230) that is used when the control engine 206 communicates with (e.g., sends signals to, receives signals from) the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170. In some cases, the communication module 208 accesses the stored data 234 to determine which communication protocol is within the capability of the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170 for a communication signal sent by the control engine 206. In addition, the communication module 208 can interpret the communication protocol of a communication signal received by the controller 104 (e.g., from a user system 155, from the network manager 180, from a sensor device 165) so that the control engine 206 can interpret the contents of the communication signal.

The communication module 208 can send and receive data between the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170 and the controller 104. The communication module 208 can send and/or receive data in a given format that follows a particular protocol 232. The control engine 206 can interpret the data packet received from the communication module 208 using a protocol 232 stored in the storage repository 230.

The communication module 208 can send data (e.g., protocols 232, stored data 234) directly to and/or retrieve data directly from the storage repository 230. Alternatively, the control engine 206 can facilitate the transfer of data between the communication module 208 and the storage repository 230. The communication module 208 can also provide encryption to data that is sent by the controller 104 and decryption to data that is received by the controller 104. The communication module 208 can also provide one or more of a number of other services with respect to data sent from and received by the controller 104. Such services can include, but are not limited to, data packet routing information and procedures to follow in the event of data interruption.

The timer 210 of the controller 104 can track clock time, intervals of time, an amount of time, and/or any other measure of time. The timer 210 can also count the number of occurrences of an event, whether with or without respect to time. Alternatively, the control engine 206 can perform the counting function. The timer 210 is able to track multiple time measurements concurrently. The timer 210 can track time periods based on an instruction received from the control engine 206, based on an instruction received from another component (e.g., a user 150 (including an associated user system 155, the network manager 180) of the system 100, based on an instruction programmed in the software for the controller 104, based on some other condition or from some other component, or from any combination thereof.

The timer 210 can be configured to track time when there is no power delivered to the controller 104 (e.g., the power module 212 malfunctions) using, for example, a super capacitor or a battery backup. In such a case, when there is a resumption of power delivery to the controller 104, the timer 210 can communicate any aspect of time to the controller 104. In such a case, the timer 210 can include one or more of a number of components (e.g., a super capacitor, an integrated circuit) to perform these functions.

The power module 212 of the controller 104 provides power to one or more other components (e.g., timer 210, control engine 206) of the controller 104. In addition, in certain example embodiments, the power module 212 can provide power to the power supply 140 of the organizing apparatus 170. The power module 212 can include one or more of a number of single or multiple discrete components (e.g., transistor, diode, resistor), and/or a microprocessor. The power module 212 may include a printed circuit board, upon which the microprocessor and/or one or more discrete components are positioned. In some cases, the power module 212 can include one or more components that allow the power module 212 to measure one or more elements of power (e.g., voltage, current) that is delivered to and/or sent from the power module 212.

The power module 212 can include one or more components (e.g., a transformer, a diode bridge, an inverter, a converter) that receives power (for example, through an electrical cable) from the power supply 140 of the organizing apparatus 170. The power module 212 can then subsequently generate power of a type (e.g., alternating current, direct current) and level (e.g., 12V, 24V, 120V) that can be used by the other components of the controller 104. In addition, or in the alternative, the power module 212 can be or include a source of power in itself to provide signals to the other components of the controller 104. For example, the power module 212 can be or include an energy storage device (e.g., a battery). As another example, the power module 212 can be or include a localized photovoltaic power system.

The power module 212 can use a closed control loop to maintain a preconfigured voltage or current with a tight tolerance at the output. The power module 212 can also protect the rest of the electronics (e.g., hardware processor 220, transceiver 224) in the controller 104 from surges generated in the line. The power module 212 can also have sufficient isolation in the associated components of the power module 212 (e.g., transformers, opto-couplers, current and voltage limiting devices) so that the power module 212 is certified to provide power to an intrinsically safe circuit.

In certain example embodiments, the power module 212 of the controller 104 can also provide power and/or control signals, directly or indirectly, to one or more of the sensor devices 165. In such a case, the control engine 206 can direct the power generated by the power module 212 to the sensor devices 165 of the organizing apparatus 170. In this way, power can be conserved by sending power to the sensor devices 165 of the organizing apparatus 170 when those devices need power, as determined by the control engine 206.

The hardware processor 220 of the controller 104 executes software in accordance with one or more example embodiments. Specifically, the hardware processor 220 can execute software on the control engine 206 or any other portion of the controller 104, as well as software used by the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170. The hardware processor 220 can be or include an integrated circuit (IC), a central processing unit, a multi-core processing chip, a multi-chip module including multiple multi-core processing chips, or other hardware processor in one or more example embodiments. The hardware processor 220 can be known by other names, including but not limited to a computer processor, a microprocessor, and a multi-core processor.

In one or more example embodiments, the hardware processor 220 executes software instructions stored in memory 222. The memory 222 includes one or more cache memories, main memory, and/or any other suitable type of memory. The memory 222 is discretely located within the controller 104 relative to the hardware processor 220 according to some example embodiments. In certain configurations, the memory 222 can be integrated with the hardware processor 220.

In certain example embodiments, the controller 104 does not include a hardware processor 220. In such a case, the controller 104 can include, as an example, one or more field programmable gate arrays (FPGA), one or more insulated-gate bipolar transistors (IGBTs), and/or one or more ICs. Using FPGAs, IGBTs, ICs, and/or other similar devices known in the art allows the controller 104 (or portions thereof) to be programmable and function according to certain logic rules and thresholds without the use of a hardware processor 220. Alternatively, FPGAs, IGBTs, ICs, and/or similar devices can be used in conjunction with one or more hardware processors 220.

The transceiver 224 of the controller 104 can send (using a transmitter and the communication links 105) and/or receive (using a receiver and the communication links 105) control and/or communication signals, including RF signals. Specifically, the transceiver 224 can be used to transfer data between the controller 104 and the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170. The transceiver 224 can use wired and/or wireless technology. The transceiver 224 can be configured in such a way that the control and/or communication signals sent and/or received by the transceiver 224 can be received and/or sent by another transceiver that is part of the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170.

When the transceiver 224 uses wireless technology, any type of wireless technology can be used by the transceiver 224 in sending and receiving communication signals (e.g., RF signals). Such wireless technology can include, but is not limited to, Wi-Fi, visible light communication, infrared, cellular networking, 802.15.4 wireless, 5G cellular wireless, Zigbee, BLE, UWB, and Bluetooth. For example, the transceiver 224 can include a Zigbee transmitter, a Zigbee receiver, a BLE receiver, a BLE transmitter, an active IR transmitter, and/or an active IR receiver. The transceiver 224 can use one or more of any number of suitable communication protocols (e.g., ISA100, HART) when sending and/or receiving communication signals, including RF signals. Such communication protocols can be stored in the protocols 232 of the storage repository 230. Further, any transceiver information for the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170 can be part of the stored data 234 (or similar areas) of the storage repository 230.

Optionally, in one or more example embodiments, the security module 228 secures interactions between the controller 104, the network manager 180, the one or more user systems 155 (including any sensor devices 265), and/or one or more of the other components (e.g., the sensor devices 165, the user interface 129, the power supply 140, the handling devices 172, other controllers 104) of the organizing apparatus 170. More specifically, the security module 228 authenticates communication from software based on security keys verifying the identity of the source of the communication. For example, user software may be associated with a security key enabling the software of the network manager 180 to interact with the controller 104 of the organizing apparatus 170.

Further, the security module 228 can restrict receipt of information, requests for information, and/or access to information in some example embodiments. For example, the security module 228 may include one or more parental control features. Such parental control features may include, but are not limited to, putting a limit on the amount of time that a particular user 150 may be engaged with the organizing apparatus 170, limiting the types of assemblies that may be recommended to a particular user 150, and determining whether a particular user 150 may engage with the organizing apparatus 170, including certain features and/or aspects.

FIG. 3 illustrates one embodiment of a computing device 318 that implements one or more of the various techniques described herein, and which is representative, in whole or in part, of the elements described herein pursuant to certain exemplary embodiments. For example, a controller 104 of the organizing apparatus 170 (including components thereof, such as the control engine 206, the hardware processor 220, the storage repository 230, and the transceiver 224) can be considered a computing device 318. The computing device 318 shown in FIG. 3 is one example embodiment and is not intended to suggest any limitation as to scope of use or functionality of the computing device 318 and/or its possible architectures. Neither should the computing device 318 be interpreted as having any dependency or requirement relating to any one or combination of components illustrated in the example computing device 318.

The computing device 318 of FIG. 3 includes one or more processors or processing units 314, one or more memory/storage components 315, one or more input/output (I/O) devices 316, and a bus 317 that allows the various components and devices to communicate with one another. Bus 317 represents one or more of any of several types of bus structures, including a memory bus or memory controller, a peripheral bus, an accelerated graphics port, and a processor or local bus using any of a variety of bus architectures. Bus 317 includes wired and/or wireless buses.

Memory/storage component 315 represents one or more computer storage media. Memory/storage component 315 includes volatile media (such as random access memory (RAM)) and/or nonvolatile media (such as read only memory (ROM), flash memory, optical disks, magnetic disks, and so forth). Memory/storage component 315 includes fixed media (e.g., RAM, ROM, a fixed hard drive, etc.) as well as removable media (e.g., a Flash memory drive, a removable hard drive, an optical disk, and so forth).

One or more I/O devices 316 allow a customer, utility, or other user to enter commands and information to the computing device 318, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques is stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, cloud-based storage, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 318 of FIG. 3 is connected to a network (not shown) (e.g., LAN, a WAN such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer device 318 includes at least the minimal processing, input, and/or output means necessary to practice one or more embodiments.

Further, those skilled in the art will appreciate that one or more elements of the aforementioned computer device 318 is located at a remote location and connected to the other elements over a network in certain exemplary embodiments. Further, one or more embodiments are implemented on a distributed system having one or more nodes, where each portion of the implementation (e.g., the control engine 206) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

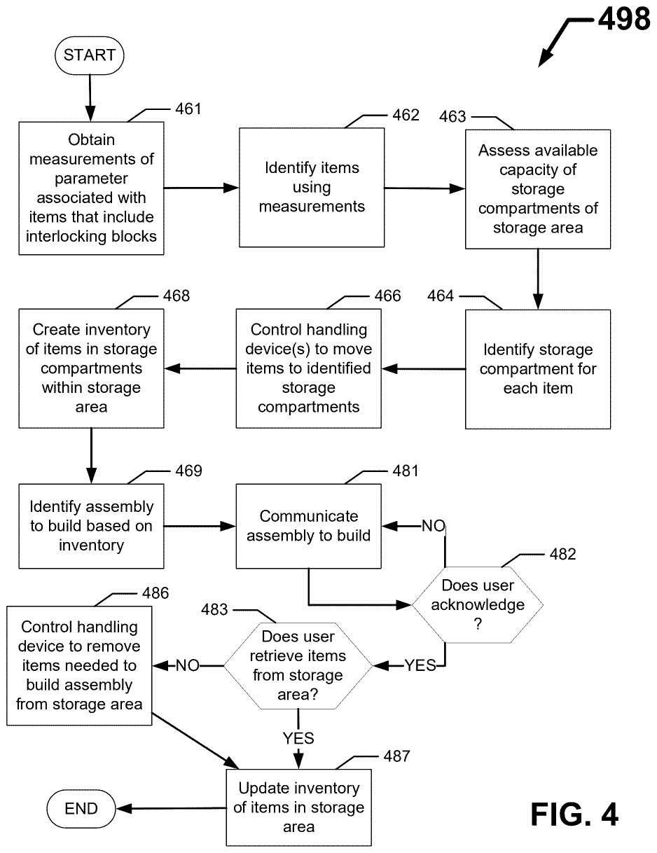

FIG. 4 shows a flowchart 498 of a method for organizing interlocking toy bricks and associated items 190 in accordance with certain example embodiments. While the various steps in the method captured in the flowchart 498 of FIG. 4 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 4 may be included in performing this method. Accordingly, the specific arrangement of steps should not be construed as limiting the scope. Further, a particular computing device, such as the computing device discussed above with respect to FIG. 3, can be used to perform one or more of the steps for the methods shown in FIG. 4 in certain example embodiments. Any of the functions performed below by a controller (e.g., controller 104) of a organizing apparatus (e.g., organizing apparatus 170) can involve the use of one or more protocols (e.g., protocols 232), one or more algorithms (e.g., algorithms 233), and/or stored data (e.g., stored data 234) stored in a storage repository (e.g., storage repository 230).

The method shown in the flowchart 498 of FIG. 4 is merely an example that can be performed by using an example system described herein. In other words, systems for organizing interlocking toy bricks and associated items 190 can perform other functions using other methods in addition to and/or aside from those shown in FIG. 4. Referring to the description above with respect to FIGS. 1 through 3, the method shown in the flowchart 498 of FIG. 4 begins at the START step and proceeds to step 461, where measurements of one or more parameters associated with items 190 that include interlocking toy blocks are obtained. As used herein, the term “obtaining” may include collecting, receiving, retrieving, accessing, generating, etc. or any other manner of coming into possession of, in this case, measurements of parameters associated with items 190. Measurements of the parameters associated with the items 190 may be made, directly or indirectly, using one or more sensor devices 165 of the organizing apparatus 170 and/or one or more sensor devices 265 of a user system 155.

The measurements of the parameters associated with the items 190 may be taken in the volume of space 199 outside the housing 128 of the organizing apparatus 170, within a receiving compartment 174 of the organizing apparatus 170, inside the housing 128 of the organizing apparatus 170, and/or at some other location. Examples of the parameters that are measured and obtained may include, but are not limited to, the color of an item 190, the size (e.g., length, width, height) of an item 190, the shape of an item 190, the manufacturer of an item 190, the design number of an item 190, other types of markings on the item 190, the number of interlocking features on an item 190, the location of the interlocking features on an item 190, the type (e.g., stud, tube) of interlocking features on an item 190, and the dimensions of the interlocking features on an item 190.

Some or all of the process of obtaining measurements of parameters associated with the items 190 may be controlled by a controller 104 (or the item recognition module 236 thereof) of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, some or all of the process of obtaining measurements of parameters associated with the items 190 may be controlled by a user 150, including an associated user system 155, via the user interface 129 of the organizing apparatus 170. The measurements of parameters associated with the items 190 may be obtained continuously over an extended period of time or on a discrete basis. The measurements of parameters associated with the items 190 may be obtained from one or more sensor devices 165 of the organizing apparatus 170, one or more sensor devices 265 of one or more user systems 155, and/or some other source of information.

In step 462, the items 190 are identified using the measurements that were obtained. Some or all of the items 190 may be identified by the item recognition module 236 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, some or all of the items 190 may be identified by a user 150, including an associated user system 155, via the user interface 129 of the organizing apparatus 170.

In some cases, additional information may be needed before an item 190 may be identified. For example, one or more measurements that are obtained may be erroneous (e.g., caused by a faulty sensor device 165, due to a lack of focus of a sensor device 265 in the form of a camera), causing a conflict with other measurements that are made of the same item 190. As another example, too few measurements of an item 190 have been obtained, resulting in multiple possible identifications of an item 190. In such cases, a controller 104 (including the item recognition module 236 thereof) of the organizing apparatus 170 may control one or more other components (e.g., a sensor device 165, a handling device 172) of the organizing apparatus 170 to take additional measurements of parameters associated with the item 190 that may be obtained, as in step 461 above. The determination that additional information is needed before an item 190 may be correctly identified may be made by the item recognition module 236 of a controller 104 of the organizing apparatus 170.

In step 463, the available capacity of the storage compartments 175 within the storage area 176 of the organizing apparatus 170 is assessed. The available capacity of the storage compartments 175 within the storage area 176 of the organizing apparatus 170 may be assessed by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, the available capacity of the storage compartments 175 within the storage area 176 of the organizing apparatus 170 may be assessed by a user 150, including an associated user system 155, via the user interface 129 of the organizing apparatus 170.

When the storage compartments 175 have sufficient capacity for additional items 190, no changes to the operation of the organizing apparatus 170 may be implemented. If the available capacity of a storage compartment 175 within the storage area 176 of the organizing apparatus 170 is limited or zero (e.g., based on a threshold value), one or more options may be pursued to resolve the capacity issue. For example, when a storage compartment 175 is determined to be at or near capacity, the inventory management module 237 of a controller 104 of the organizing apparatus 170 may control one or more handling devices 172 to remove some items 190 (e.g., particular items 190) or all of the items 190 from the storage compartment 175 that is determined to be at or near capacity to another storage compartment 175 that is determined to be under capacity.

As another example, when a storage compartment 175 is determined to be at or near capacity, the inventory management module 237 of a controller 104 of the organizing apparatus 170 may communicate with a user 150 via the user interface 129 to replace the storage compartment 175 that is determined to be at or near capacity with another storage compartment 175 that is under capacity. As another example, when a storage compartment 175 is determined to be at or near capacity, the inventory management module 237 of a controller 104 of the organizing apparatus 170 may control one or more handling devices 172 to place subsequent items 190 that would otherwise be placed in the storage compartment 175 that is determined to be at or near capacity into another particular storage compartment 175 as overflow.

In step 464, a storage compartment 175 within the storage area 176 is identified for each item 190. A storage compartment 175 may be identified for an item 190 by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, a storage compartment 175 may be identified for an item 190 by a user 150, including an associated user system 155, via the user interface 129 of the organizing apparatus 170.

In step 466, one or more handling devices 172 are controlled to move an item 190 to a storage compartment 175 identified for that item 190. A handling device 172 may be controlled by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, a handling device 172 may be controlled by a user 150, including an associated user system 155, via the user interface 129 of the organizing apparatus 170.

In step 468, an inventory of items 190 in the storage compartments 175 within the storage area 176 is created. The inventory may be highly detailed (e.g., all known characteristics of each item 190 stored in each storage compartment 175) or have minimal information (e.g., number of items 190 stored in each storage compartment 175, number of items 190 stored in the storage area 176). The inventory may be maintained continually, periodically (every hour, every 24 hours), based on the occurrence of an event (e.g., the addition or removal of an item 190 from the storage area 176), and/or based on some other factor. The inventory may be specific to each storage compartment 175 (including applicable portions within each storage compartment 175) and/or for the storage area 176 in general.

The inventory of items 190 in the storage compartments 175 within the storage area 176 may be created by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, the inventory of items 190 in the storage compartments 175 within the storage area 176 may be created by a user 150, including an associated user system 155, via the user interface 129 of the organizing apparatus 170.

In step 469, one or more assemblies to build based on the inventory are identified. As discussed above, an assembly is a finished product (e.g., an object) that results by combining specific items 190, often in a specific way. Each potential assembly may be identified based on one or more of a number of factors, including but not limited to preferences of a user 150, recent assemblies created by a user 150, a request from a user 150, recent local, national, and/or international trends, size of the assembly, projected time to complete the assembly, and complexity of the assembly. In some cases, an assembly that is identified may require additional items that are not currently in inventory within the storage area 176. For example, such additional items may be part of an assembly of the user 150 that is already built. As another example, such additional items may be purchased from a vendor identified by the controller 104 of the organizing apparatus 170.

An assembly to potentially be built based on inventory may be identified by the mapping module 238 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, an assembly to potentially be built based on inventory may be identified by a user 150, including an associated user system 155, via the user interface 129 of the organizing apparatus 170.

In step 481, an assembly to build is communicated. The assembly to build may be among the assemblies identified in step 469 above. In such a case, the assembly that is selected may be based on one or more of a number of factors, including but not limited to preferences of a user 150, recent assemblies created by a user 150, a request from a user 150, recent local, national, and/or international trends, size of the assembly, projected time to complete the assembly, and complexity of the assembly. The assembly to build may be accompanied by additional information about the assembly. Such additional information may include, but is not limited to, one or more images of the completed assembly, a detailed list of the items 190 required for the assembly, steps or phases that may be taken to complete the assembly, and suggestions by other users 150 who have previously completed the assembly.

The assembly to build may be selected by the recommendation module 239 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, an assembly to build may be selected by a user 150, including an associated user system 155, via the user interface 129 of the organizing apparatus 170. Communication of the assembly to build may be made by the recommendation module 239 of a controller 104 of the organizing apparatus 170 using the communication module 208, the application interface 226, the user interface 129, one or more protocols 232, one or more algorithms 233 (e.g., models), stored data 234, one or more sensor devices 165, one or more sensor devices 265, and/or input from a user 150 (which may include an associated user system 155).

In step 482, a determination is made as to whether the user 150 acknowledges the assembly to be built. The user 150 may acknowledge the assembly to be built using the user interface 129 (e.g., by direct interaction, using a user system 155) of the organizing apparatus 170. If the user 150 acknowledges the assembly to be built, then the process proceeds to step 483. If the user 150 does not acknowledge the assembly to be built, then the process reverts to step 481.

In step 483, a determination is made as to whether the user 150 retrieves the items 190 needed to complete the assembly from the storage area 176. The user 150 may communicate, through the user interface 129 (e.g., using direct physical interaction, using a user system 155) of the organizing apparatus 170, to the controller 104 of the organizing apparatus 170 as to whether the user 150 retrieves the items 190. If the user 150 retrieves the items 190 needed to complete the assembly from the storage area 176, then the process proceeds to step 487. If the user 150 does not retrieve the items 190 needed to complete the assembly from the storage area 176, then the process proceeds to step 486.

In step 486, one or more handling devices 172 are controlled to remove items 190 needed to complete the assembly form the storage area 176. A handling device 172 may be selected based on one or more of a number of factors, including but not limited to the capabilities of the handling device 172 and the location of the handling device 172 relative to certain items 190 in the storage area 176. A handling device 172 may be controlled by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, a handling device 172 may be controlled by a user 150, including an associated user system 155, via the user interface 129 of the organizing apparatus 170.

In some cases, the identification of one or more items 190 removed from the storage area 176 may be verified by the item recognition module 236 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, the identification of one or more items 190 removed from the storage area 176 may be verified by a user 150, including an associated user system 155, via the user interface 129 of the organizing apparatus 170.

In step 487, the inventory of the items 190 in the storage area 176 is updated. As with step 468 above, the inventory may be highly detailed (e.g., all known characteristics of each item 190 stored in each storage compartment 175) or have minimal information (e.g., number of items 190 stored in each storage compartment 175, number of items 190 stored in the storage area 176). The inventory may be specific to each storage compartment 175 (including applicable portions within each storage compartment 175) and/or for the storage area 176 in general.

The inventory of items 190 in the storage compartments 175 within the storage area 176 may be updated by the inventory management module 237 of a controller 104 of the organizing apparatus 170 using one or more protocols 232, one or more algorithms 233 (e.g., models), stored data 234, one or more sensor devices 165, one or more sensor devices 265, and/or input from a user 150 (which may include an associated user system 155). In addition, or in the alternative, the inventory of items 190 in the storage compartments 175 within the storage area 176 may be updated by a user 150, including an associated user system 155, via the user interface 129 of the organizing apparatus 170. When step 487 is complete, the process proceeds to the END step.

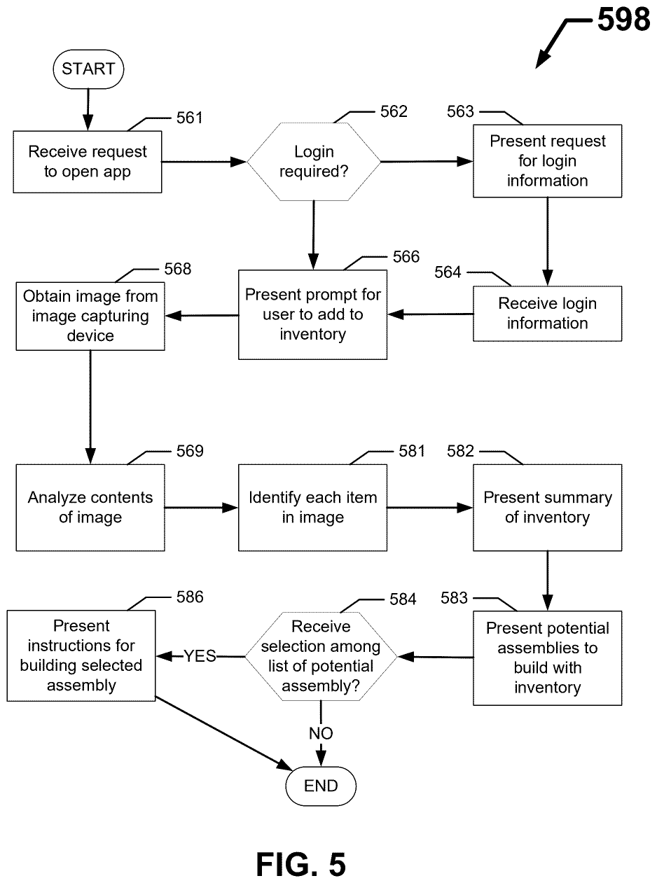

FIG. 5 shows a flowchart 598 of another method for organizing interlocking toy bricks and associated items 190 in accordance with certain example embodiments. While the various steps in the method captured in the flowchart 598 of FIG. 5 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 5 may be included in performing this method. Accordingly, the specific arrangement of steps should not be construed as limiting the scope. Further, a particular computing device, such as the computing device discussed above with respect to FIG. 3, can be used to perform one or more of the steps for the method shown in FIG. 5 in certain example embodiments. Any of the functions performed below by a controller (e.g., controller 104) of a organizing apparatus (e.g., organizing apparatus 170) and/or a controller (e.g., similar to a controller 104 of the organizing apparatus 170) on a user system 155 can involve the use of one or more protocols (e.g., protocols 232), one or more algorithms (e.g., algorithms 233), and/or stored data (e.g., stored data 234) stored in a storage repository (e.g., storage repository 230), whether as part of the organizing apparatus 170 and/or a user system 155.

The method shown in the flowchart 598 of FIG. 5 is merely an example that can be performed by using an example system described herein. In other words, systems for organizing interlocking toy bricks and associated items 190 can perform other functions using other methods in addition to and/or aside from those shown in FIG. 5. Referring to the description above with respect to FIGS. 1 through 4, the method shown in the flowchart 598 of FIG. 5 begins at the START step and proceeds to step 561, where a request to open an app is received. The request may be received by the user system 155. The request may be initiated by a user 150. The request may be communicated using the user interface 129 of the organizing apparatus 170. In addition, or in the alternative, the request may be made on the user system 155. For example, as shown in FIG. 6, the user interface 629 of the user system 655 (in this example, a smart phone) can be a touch screen, and the instruction to open the app 691 occurs when the user (e.g. user 150) touches the icon for the app 691 on the touch screen. The user system 655 is substantially similar to the user system 155 discussed above, and the user interface 629 of the user system 655 has features that are similar to the user interface 129 of the organizing apparatus 170 discussed above.

In step 562, a determination is made as to whether login information is required to open the app (e.g., the app 691 of FIG. 6). If login information is required to open the app 691, then the process proceeds to step 563. If login information is not required to open the app 691, then the process proceeds to step 566. In step 563, a request for login information is presented. The request for login information is presented on the user interface 629 of the user system 655. In step 564, the login information is received. The login information is received on the user interface 629 of the user system 655.

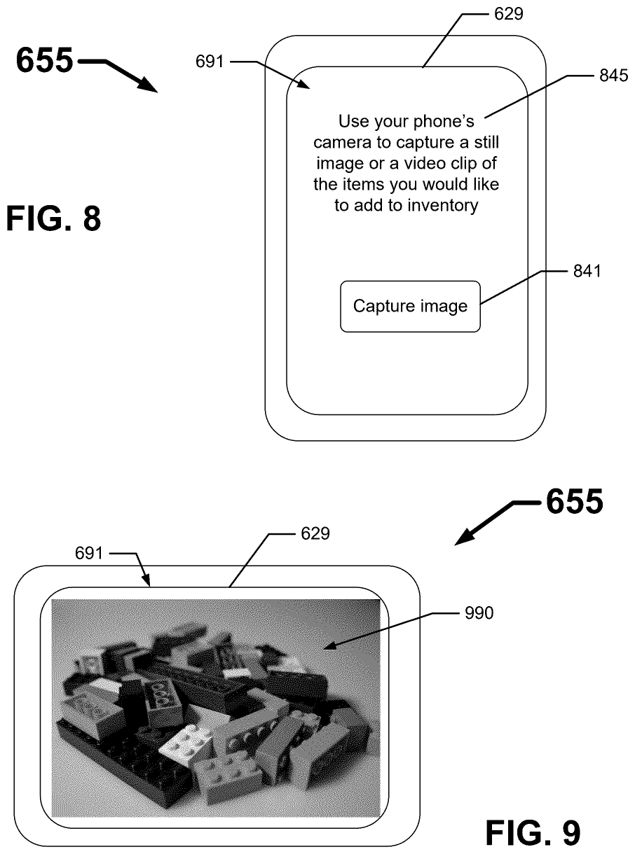

In step 566, a prompt is presented for a user 150 to add items 190 to inventory. The prompt to add items 190 to inventory is presented on the user interface 629 of the user system 655. In some cases, additional prompts may also be presented on the user interface 629. For example, as shown in FIG. 7, the user interface 629 of the user system 655 from FIG. 6 shows three prompts 741 in response to the query 745: “What would you like to do?”. Prompt 741-1 is an option to add to inventory, prompt 741-2 is an option to build an assembly, and prompt 741-3 is an option to see the current inventory. The query 745 and the prompts 741 are generated and presented by the app 691 on the user interface 629 (in this case, the touch screen). When a user 150 selects the prompt 741-1 to add to inventory, a secondary screen with another prompt 841 may appear, as shown in FIG. 8. In this case, the user interface 629 of the user system 655 of FIG. 8 shows a statement 845 that the user 150 can use the phone's camera to capture a still image or a video clip of the items that the user 150 would like to add to inventory. The prompt 841 on the user interface 629 of FIG. 8 is an option to capture an image. When the prompt 841 is selected and the image is captured, then the process proceeds to step 568.

In step 568, one or more images are obtained from an image capturing device of the user system 155. The image obtained from the image capturing device (a form of a sensor device 265) includes one or more items 190. For example, as shown in FIG. 9 below, the user interface 629 of the user system 655 from FIG. 8 shows a still image of multiple items 990 that are captured by the image capturing device of the user system 655.

In step 569, the contents of the image are analyzed. The contents of the image may be analyzed by the item recognition module 236 of a controller 104 of the organizing apparatus 170 that is in communication with the app 691 (e.g., via the user interface 129 of the organizing apparatus 170) and/or using parts of the app 691 that have functionality that is equivalent to the functions performed by the item recognition module 236. This step is substantially equivalent or functionally equivalent to step 461 of FIG. 4 discussed above. For example, if additional information is needed to analyze the contents of the original image, the app 691 may prompt a user 150 via the user interface 691 of the user system 655 to capture additional images.

In step 581, each item 190 in the image is identified. Each item 190 (or in the case of FIG. 9, each item 990) in the image may be identified by the item recognition module 236 of a controller 104 of the organizing apparatus 170 that is in communication with the app 691 (e.g., via the user interface 129 of the organizing apparatus 170) and/or using parts of the app 691 that have functionality that is equivalent to the functions performed by the item recognition module 236. This step is substantially equivalent or functionally equivalent to step 462 of FIG. 4 discussed above.

In step 582, a summary of the inventory is presented. The summary of the inventory may be presented using the user interface 129 of the organizing apparatus 170. In addition, or in the alternative, the summary of the inventory may be presented on a user interface (e.g., user interface 629) of the user system 155. The summary of the inventory that is presented may be highly detailed (e.g., all known characteristics of each item 190 stored in the storage area 176) or have minimal information (e.g., number of items 190 stored in each storage compartment 175 (where the volume of space 199 in which the items 190 added to inventory may be considered a storage compartment 175), number of items 190 stored in the storage area 176). The inventory may be specific to each storage compartment 175 (including applicable portions (e.g., sub-compartments, divisions) within each storage compartment 175) and/or for the storage area 176 in general. The summary of the inventory may be created by the inventory management module 237 of a controller 104 of the organizing apparatus 170 and/or using parts of the app 691 that have functionality that is equivalent to the functions performed by the inventory management module 237.

In step 583, one or more potential assemblies to build with the inventory are presented. The potential assemblies to build with the current inventory may be presented using the user interface 129 of the organizing apparatus 170. In addition, or in the alternative, the potential assemblies to build with the current inventory may be presented on a user interface of the user system 155. This step is substantially equivalent or functionally equivalent to step 469 and step 481 of FIG. 4 discussed above. In some cases, rather than presenting a list of potential assemblies to build with the current inventory and/or making a recommendation as to what the user 150 may build based on the current inventory, the app 691 may ask the user 150, via the user interface 629, an open-ended question such as “What would you like to build?”. As another alternative, in addition to presenting a potential list of assemblies, the app 691 may allow a user 150 to provide (e.g., in a blank space that accepts freeform responses) an assembly that is not on the list.

In step 584, a determination is made as to whether an option among the list of potential assemblies has been selected. An option may be selected by a user 150 through the app 691 on the user interface 629 on the user system 655 and/or through the user interface 129 of the organizing apparatus 170. Alternatively, as discussed above with respect to step 583, an option that is not among the list of potential assemblies may be provided by a user 150. If an option among the list of potential assemblies has been selected, then the process proceeds to step 586. If an option among the list of potential assemblies has not been selected, then the process proceeds to the END step.

Alternatively, if an option among the list of potential assemblies has not been selected, rather than proceeding directly to the END step, the recommendation module 239 of a controller 104 of the organizing apparatus 170 may provide instructions (e.g., finding the instructions on a third-party website, generating a set of instructions based on training of the protocols 232 and/or algorithms 233, a listing of items 190 used in the assembly (e.g., broken down by what is currently in inventory and what is not currently in inventory)) to the user 150. In addition, in such cases, the inventory management module 237 of a controller 104 of the organizing apparatus 170 may provide a list of needed items 190 that are currently not in inventory, provide options as to where the needed items 190 may be found, and/or obtain (e.g., through a vendor, through third party resellers) items 190 needed for the assembly that are not currently in inventory. In the latter instance, the app 691 may seek approval (e.g., in terms of an amount of money, in terms of a form of payment) from the user 150 before proceeding to obtain the items 190 needed for the assembly that are not currently in inventory.

In step 586, instructions for building the selected assembly are presented. The instructions may be presented using the user interface 129 of the organizing apparatus 170. In addition, or in the alternative, the instructions may be presented on a user interface of the user system 155. The instructions may be generated by the recommendation module 239 of a controller 104 of the organizing apparatus 170. The instructions may include detailed steps, a detailed inventory of items 190 needed, images of subassemblies, images of the completed assembly, and/or any other information that may be useful in providing guidance to a user 150 to complete the assembly. In some cases, the app 691 may communicate the selected assembly to a controller 104 of the organizing apparatus 170 so that the controller 104 may remove the items 190 required for the selected assembly from the storage area 176. When step 586 is completed, the process proceeds to the END step.

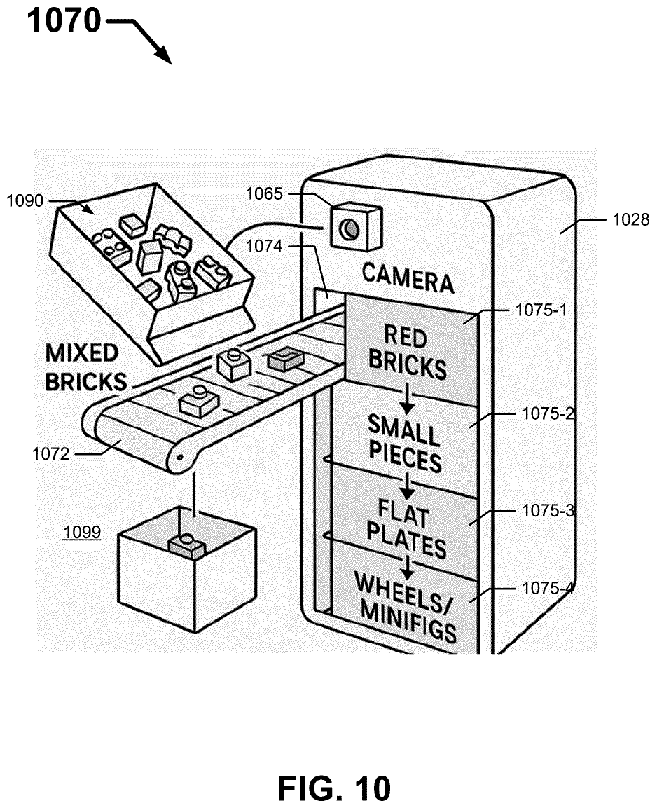

FIG. 10 shows an organizing apparatus 1070 according to certain example embodiments. Referring to the description above with respect to FIGS. 1 through 9, the organizing apparatus 1070 of FIG. 10 includes a housing 1028 that is in the shape of a three-dimensional rectangle. The organizing apparatus 1070 also has a receiving compartment 1074 in the form of an aperture in a side wall of the housing 1028. Within the receiving compartment 1074 is a handling device 1072 in the form of a conveyer belt that starts outside the housing 1028 in the volume of space 1099 and extends through the receiving compartment 1074 inside the housing 1028. The handling device 1072 receives items 1090 that are placed (e.g., poured) thereon outside the housing 1028. The organizing apparatus 1070 also includes a sensor device 1065 in the form of an image capturing device (e.g., a camera) that is mounted on the wall of the housing 1028 and is directed toward the portion of the handling device 1072 that receives the items 1090 outside the housing 1028. A controller (e.g., similar to a controller 104 discussed above) is configured to identify and organize the items 1090 by placing (e.g., using other handling devices 1072 inside the housing 1028) the items 1090 into one of four storage compartments 1075 (storage compartment 1075-1 for red bricks, storage compartment 1075-2 for small pieces, storage compartment 1075-3 for flat pieces, and storage compartment 1075-4 for wheels and miniature figures).

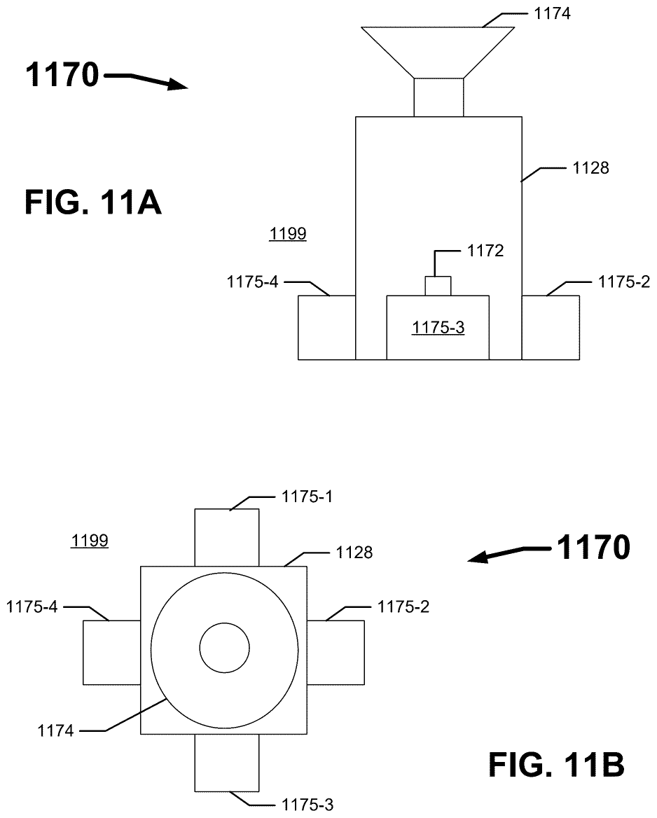

FIGS. 11A and 11B show a rear view and a top view, respectively, of another organizing apparatus 1170 according to certain example embodiments. Referring to the description above with respect to FIGS. 1 through 10, the organizing apparatus 1170 of FIGS. 11A and 11B includes a housing 1128 that is in the shape of a three-dimensional rectangle. The organizing apparatus 1170 also has a receiving compartment 1174 in the form of an aperture with a funnel in the top of the housing 928. Items (e.g., items 190) are dumped into the receiving compartment 1174 by a user (e.g., user 150). Once the items are inside the housing 1128, a controller (e.g., similar to a controller 114) controls one or more handling devices (e.g., similar to the handling devices 172) and one or more sensor devices (e.g., similar to the sensor devices 165) identify the items and subsequently distribute the items into the appropriate storage compartment 975.

In this case, there are four storage compartments 1175 (storage compartment 1175-1 abutting the front wall of the housing 1128, storage compartment 1175-2 abutting the left side wall of the housing 1128, storage compartment 1175-3 abutting the rear wall of the housing 1128, and storage compartment 1175-4 abutting the right side wall of the housing 1128) located outside the housing 1128 in the volume of space 1199. Items leave the housing 1128 through a handling device 1172 in the form of an aperture (shown in the rear wall of the housing 1128 in FIG. 11A) so that the items fall into their respective storage compartment 1175.

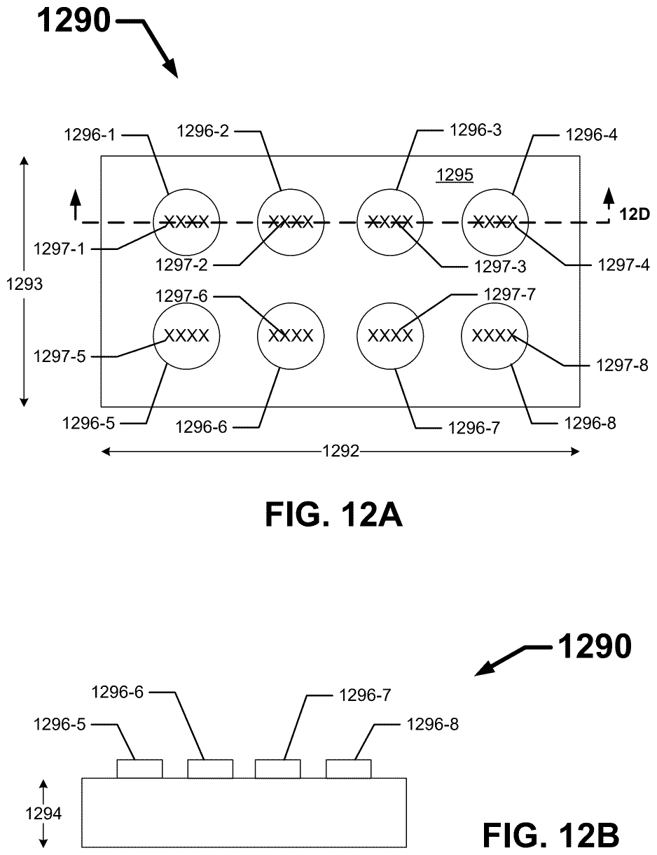

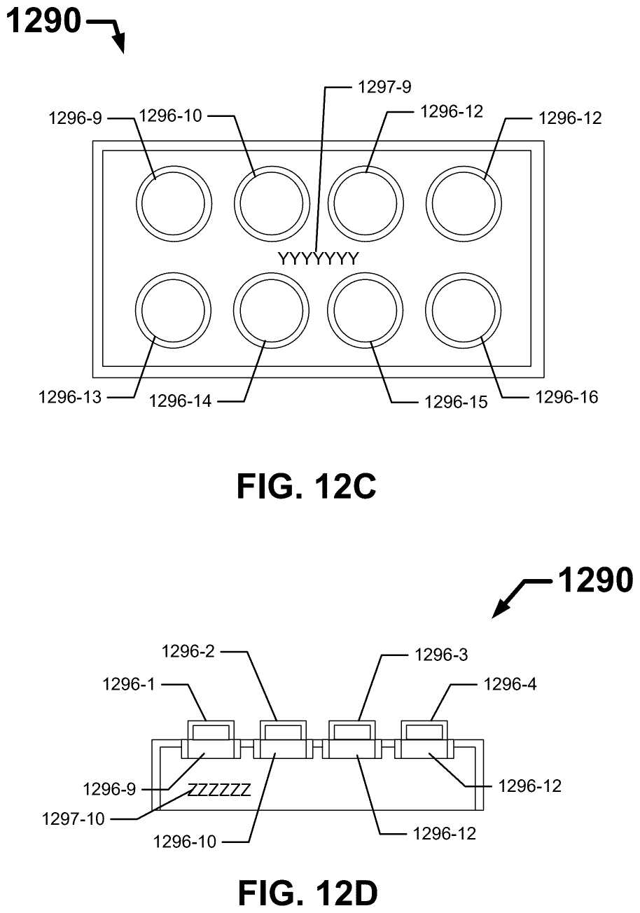

FIGS. 12A through 12D show various views of an item 1290 in the form of a toy interlocking brick according to certain example embodiments. Specifically, FIG. 12A shows a top view of the item 1290. FIG. 12B shows a side view of the item 1290. FIG. 12C shows a bottom view of the item 1290. FIG. 12D shows a sectional side view of the item 1290. Referring to the description above with respect to FIGS. 1 through 11B, the item 1290 of FIGS. 12A through 12D has a body 1295 with a length 1292, a width 1293, and a height 1294. In this case, the body 1295 has a solid top wall and side walls, and the body 1295 has a hollow underside.

The item 1290 of FIGS. 12A through 12D has 16 interlocking features 1296. Extending upward from the top surface of the top wall of the body 1295 are 8 interlocking features 1296 (interlocking feature 1296-1, interlocking feature 1296-2, interlocking feature 1296-3, interlocking feature 1296-4, interlocking feature 1296-5, interlocking feature 1296-6, interlocking feature 1296-7, and interlocking feature 1296-8) in the form of studs. (It is noted that a stud is a term in the art for a protrusion used as an interlocking feature.) The studs (interlocking feature 1296-1 through interlocking feature 1296-8) are arranged in two rows of four, and each stud is cylindrical in shape (e.g., has a circular shape when viewed from above). In alternative embodiments, the studs of the item 1290 may have a different number (e.g., 1, 2, 5, 10, 15), have a different arrangement (e.g., 1×6, 2×8, 3×3, 1×1), have different shapes (e.g., has a square shape when viewed from above), and/or other different configurations.

The other 8 interlocking features 1296 (interlocking feature 1296-9, interlocking feature 1296-10, interlocking feature 1296-12, interlocking feature 1296-12, interlocking feature 1296-13, interlocking feature 1296-14, interlocking feature 1296-15, and interlocking feature 1296-16) are in the form of tubes that extend downward from the bottom surface of the top wall of the body 1295. (It is noted that a tube is a term in the art for a recess used as an interlocking feature.) The tubes (interlocking feature 1296-9 through interlocking feature 1296-16) are arranged in two rows of four, and each tube is cylindrical in shape (e.g., has a circular shape when viewed from below). In alternative embodiments, the tubes of the item 1290 may have a different number (e.g., 1, 2, 5, 10, 15), have a different arrangement (e.g., 1×6, 2×8, 3×3, 1×1), have different shapes (e.g., has a square shape when viewed from below), and/or other different configurations.

The item 1290 of FIGS. 12A through 12D also includes a total of 10 markings 1297. As shown in FIG. 12A, disposed on the top surface of each of the 8 interlocking features 1296 (interlocking features 1296-1 through 1296-8) in the form of studs are identical markings 1297 in the form of a manufacturer name, a manufacturer logo, and/or some other form of marking. Specifically, marking 1297-1 is disposed atop interlocking feature 1296-1, marking 1297-2 is disposed atop interlocking feature 1296-2, marking 1297-3 is disposed atop interlocking feature 1296-3, marking 1297-4 is disposed atop interlocking feature 1296-4, marking 1297-5 is disposed atop interlocking feature 1296-5, marking 1297-6 is disposed atop interlocking feature 1296-6, marking 1297-7 is disposed atop interlocking feature 1296-7, and marking 1297-8 is disposed atop interlocking feature 1296-8.

In addition, as shown in FIG. 12C, marking 1297-9 in the form of a serial number, a model number, and/or some other form of marking is disposed on the bottom surface of the top wall of the body 1295. Further, as shown in FIG. 12D, marking 1297-10 in the form of a model number, a serial number, and/or some other form of marking is disposed on the inner surface of a side wall of the body 1295. In some alternative cases, the item 1290 has no markings. In other cases, the item 1290 has different types of markings, a different number of markings, and/or a different location of the markings with respect to what is shown in FIGS. 12A through 12D. Example embodiments can be used to provide for organizing interlocking toy bricks and associated items. Example embodiments can be used to assist a user become exposed to ideas regarding assemblies that may be built using the items (e.g., interlocking toy bricks) in possession of the user. Example embodiments can save time and resources. Example embodiments may be used to prevent clutter and items from being walking hazards. Example embodiments encourage and enhance creative play while reducing cleanup burden.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An interlocking toy brick organizing apparatus comprising:
a receiving compartment configured to receive a plurality of items comprising interlocking toy bricks;
a sensor device configured to measure a parameter associated with each item that enters the receiving compartment;
a storage area configured to store each item, wherein the storage area comprises a plurality of storage compartments;
a handling device configured to move each item from the receiving compartment to the storage compartment; and
a controller configured to:
obtain measurements of the parameter made by the sensor device;
identify each item based on the measurements; and
control the handling device to move each item from the receiving compartment to one of the plurality of storage compartments of the storage area based on identifying each item.

2. The interlocking toy brick organizing apparatus of claim 1, further comprising:
a user interface communicably coupled to the controller, wherein the user interface is configured to receive an input from a user, and wherein the controller operates based on the input from the user.

3. The interlocking toy brick organizing apparatus of claim 1, wherein the sensor device comprises a camera.

4. The interlocking toy brick organizing apparatus of claim 1, wherein the controller is further configured to maintain an inventory of the plurality of items.

5. The interlocking toy brick organizing apparatus of claim 4, wherein the controller comprises a communication module that is configured to communicate the inventory.

6. The interlocking toy brick organizing apparatus of claim 4, wherein the controller is further configured to:
identify, based on the inventory, an assembly to build; and
communicate, using the communication module, the assembly to build.

7. The interlocking toy brick organizing apparatus of claim 6, wherein the controller is further configured to communicate, using the communication module, instructions on how to build the assembly.

8. The interlocking toy brick organizing apparatus of claim 6, wherein the controller is further configured to:
control the handling device to retrieve a subset of the plurality of items from the storage area, wherein the subset of items are used to build the assembly;
control the handling device to place the subset of the plurality of items in one of the plurality of storage compartments designated for the assembly; and
communicate, using the communication module, that the subset of the plurality of items are available for retrieval.

9. The interlocking toy brick organizing apparatus of claim 6, wherein the assembly to build is based on an established set of building plans.

10. The interlocking toy brick organizing apparatus of claim 6, wherein the assembly to build is based on a set of building plans generated by the controller.

11. The interlocking toy brick organizing apparatus of claim 6, wherein the assembly to build that is communicated includes a roster of the items used in the assembly.

12. The interlocking toy brick organizing apparatus of claim 6, wherein the assembly to build that is identified is based on a preference of a user interacting with the controller.

13. The interlocking toy brick organizing apparatus of claim 1, wherein the handling device is further configured to separate multiple items that are coupled together when the controller determines that at least one of the multiple items that are coupled together is not identifiable.

14. The interlocking toy brick organizing apparatus of claim 1, wherein the plurality of compartments are accessible to a user.

15. The interlocking toy brick organizing apparatus of claim 14, wherein the controller determines, based on measurements made by a second sensor device, how many items remain in each of the plurality of storage compartments after the person accesses the plurality of storage compartments.

16. The interlocking toy brick organizing apparatus of claim 1, wherein identifying each item comprises identifying at least one of a group consisting of a shape of the item, a size of the item, an interlocking feature of the item, a marking on the item, and a color of the item.

17. The interlocking toy brick organizing apparatus of claim 1, wherein the handling device comprises at least one of a group consisting of a diverter arm and a blower.

18. A method for organizing a set of interlocking toy bricks, the method comprising:
obtaining, by a controller from a sensor device, measurements of a parameter associated with each of a plurality of items, wherein the plurality of items comprises interlocking toy bricks, and wherein the sensor device measures the parameter while the plurality of items are in a receiving compartment of an organizing apparatus;
identifying, by the controller using the measurements, each item; and
controlling, by the controller, a handling device of the organizing apparatus to move each item from the receiving compartment to one of a plurality of storage compartments of a storage area based on identifying each item.

19. The method of claim 18, further comprising:
identifying an assembly to build using a subset of the items; and
communicating the assembly to build.

20. A software application used for organizing a set of interlocking toy bricks, wherein the software application is loaded on a mobile device and is configured to:
present a prompt for a user to capture an image of a plurality of items using an image capturing device on the mobile device, wherein the plurality of items comprises interlocking toy bricks;
obtain, from the image capturing device, the image;
analyze contents of the image;
identify, after analyzing the contents of the image, each of the plurality of items; and
present, after identifying each of the plurality of items, an inventory of the items.
